(19) United States
(12) Patent Application Publication
(10) Pub. No.: US 2010/0327841 A1
(43) Pub. Date: Dec. 30, 2010

(54) SEMICONDUCTOR INTEGRATED CIRCUIT DEVICE

(75) Inventors: Takayasu ITO, Kanagawa (JP); Mitsuru HIRAKI, Kanagawa (JP); Masashi HORIGUCHI, Kanagawa (JP)

Correspondence Address: MATTINGLY & MALUR, P.C., 1800 DIAGONAL ROAD, SUITE 370, ALEXANDRIA, VA, 22314, US

(73) Assignee: RENESAS ELECTRONICS CORPORATION, Kanagawa (JP)

(21) Appl. No.: 12/796,033

(22) Filed: Jun. 8, 2010

(30) Foreign Application Priority Data
Jun. 29, 2009 (JP) 2009-153702

(51) Int. Cl. G05F 3/16

(52) U.S. Cl. 323/313

(57) ABSTRACT

The present invention provides a technique for reducing current consumption in a reference voltage forming circuit without a significant increase in area while suppressing considerable degradative difference in reference voltage accuracy between a normal operation mode and a standby mode. In the standby mode, by using a clock signal fed from an oscillator circuit, the frequency-division control circuit produces an enable signal VREFON for determining ON/OFF states of the reference voltage generator circuit, the reference voltage forming circuit, and the capacitance charging regulator, and also produces a sampling/holding signal CHOLDSW for performing control so that a holding capacitor CH in a holding capacitance circuit is charged during an ON period of the reference voltage generator circuit, the reference voltage forming circuit, and the capacitance charging regulator, and so that any paths other than a leak current path are made unavailable to the holding capacitor CH during an OFF period thereof. Current consumption can be reduced significantly by intermittently turning ON/OFF the reference voltage generator circuit, the reference voltage forming circuit, and the capacitance charging regulator, each of which would otherwise consume a relatively large amount of current for operation thereof.

### CROSS-REFERENCE TO RELATED APPLICATIONS

The disclosure of Japanese Patent Application No. 2009-153702 filed on Jun. 29, 2009 including the specification, drawings and abstract is incorporated herein by reference in its entirety.

### BACKGROUND OF THE INVENTION

The present invention relates to techniques for reducing power consumption in a semiconductor integrated circuit device, and more particularly to a technique that is effectively applicable to reduction in power consumption of a reference circuit included in a semiconductor integrated circuit device in a standby mode thereof.

Recent years have seen an increasing demand for reduction in power consumption in a normal operation mode and a standby mode of a semiconductor chip, i.e., a semiconductor integrated circuit device represented by a microcomputer product or a system-on-chip (SOC) product to be incorporated in such electronic products as mobile apparatuses and non-contact electronic items, because of requirements for prolongation of internal battery service life and for operation with weak DC voltage/current extracted from radio frequency (RF) signals. While there have been significant advances in the art of chip-level leakage reduction based on techniques concerning variable control of internal-chip power supply voltage level, substrate bias control, and power supply cutoff control, it has been practiced conventionally as a matter of necessity to reduce current consumption in internal-chip circuits designed to perform constant operation in a normal operation mode and a standby mode.

In microcomputer products of a low-end class to a middle class having ordinary chip performance specifications in ordinary price ranges, it is common practice to provide such an arrangement that the level of an internal power supply voltage (Vint) for operating a central processing unit (CPU) and other internal circuits is different from that of an external power supply voltage (Vext) for input/output (I/O) operation. In most practical applications, an internal power supply circuit is included in a semiconductor chip for the following reasons: For example, a regulator for forming an internal power supply voltage (Vint) is mounted to make single-power-supply provision for an external power supply voltage (Vext) for the purpose of reduction in packaging cost; a reference voltage forming circuit is required for a charge pump circuit used to produce a positive/negative high voltage for read/write operation on a nonvolatile memory such as a flash memory; and a regulator dedicated for a random access memory (RAM) is provided in a semiconductor chip for holding a RAM supply voltage (Vint#RAM) to maintain memory conditions in a standby mode.

Since the internal power supply circuit mentioned above is provided as an internal circuit designed to perform constant operation in the normal operation mode and standby mode, low current consumption thereof is regarded as one of the key requirements in microcomputer product specifications.

Generally, in most cases, an analog circuit for forming a reference voltage in an internal power supply circuit (reference voltage forming circuit) is a major component in terms of current consumption and area requirement in the internal power supply circuit. The amount of self-consumed current in the reference voltage forming circuit is determined primarily depending on a resistance value of a resistor element used therein. Hence, it is well known that reduction in current consumption may be achieved by increasing the resistance value.

Further, according to a known technique for forming a reference voltage without using a resistor, a reference voltage forming circuit operative on the basis of a difference in metal-oxide semiconductor (MOS) transistor threshold or a MOS transistor subthreshold slope is used for reducing current consumption while circumventing an increase in area that would otherwise be incurred due to the use of a resistor, for example.

Still further, according to a known technique for reduction in power consumption in power supply circuitry, an oscillator is coupled to an operational amplifier included in a reference voltage generator circuit, and the operational amplifier is operated intermittently in response to an output voltage of the oscillator, for example (as disclosed in Patent Document 1 indicated below).

### Patent Document 1:

Japanese Unexamined Patent Publication No. 2000-250647

### SUMMARY OF THE INVENTION

Regarding the above-mentioned conventional techniques for reduction in power consumption in a reference voltage forming circuit, the present inventors have found the following problems.

In the conventional technique for reducing current consumption by increasing a resistance value of a resistor element used in a reference voltage forming circuit, the area of the resistor element increases with an increase in resistance thereof. In the manufacture of microcomputer products of a low-end class in particular, an increase in chip size will result in an increase in chip cost, giving rise to the problem that a contradiction occurs between reduction in current consumption and reduction in chip cost.

Further, in the conventional technique for reducing current consumption by using a reference voltage forming circuit operative on the basis of a difference in MOS transistor threshold or a MOS transistor subthreshold slope, the degree of reference voltage accuracy in output from the reference voltage forming circuit is sacrificed inevitably in most cases.

In situations where the degree of reference voltage accuracy is inadequate in a normal operation mode of a semiconductor chip, read/write operations on a nonvolatile memory become unreliable. In an attempt to ensure stability and reliability of internal circuits and elements of the semiconductor chip, it has been proposed to use a circuit changeover technique wherein a changeover is performed between a low-accuracy reference voltage forming circuit dedicated to a standby mode and a high-accuracy reference voltage forming circuit dedicated to a normal operation mode. With this circuit changeover technique, however, there arises a problem that variations in reference voltage level are involved at the time of a circuit changeover since the reference voltage level in the standby mode differs from that in the normal operation mode due to a difference in circuit scheme design between the low-accuracy reference voltage forming circuit dedicated to the standby mode and the high-accuracy reference voltage forming circuit dedicated to the normal operation mode.

It is therefore an object of the present invention to overcome the above-mentioned disadvantages by providing a technique for reducing current consumption in a reference voltage forming circuit without a significant increase in area while suppressing considerable degradative difference in reference voltage accuracy between a normal operation mode and a standby mode.

The above and other objects, features and advantages of the present invention will become more apparent from the following detailed description with reference to the accompanying drawings.

The representative aspects of the present invention are briefed below:

In carrying out the present invention and according to one aspect thereof, there is provided a semiconductor integrated circuit device including reference voltage forming means for forming a reference voltage, wherein the reference voltage forming means comprises: a reference voltage forming section for forming the reference voltage; and an intermittent operation control section for intermittently activating the reference voltage forming section to form the reference voltage in a standby mode for reduction in power consumption.

Further, according to another aspect of the present invention, there is provided a semiconductor integrated circuit device wherein the intermittent operation control section thereof comprises: a control signal forming section for converting a reference clock signal to a predetermined frequency-divided clock signal to form a first control signal and a second control signal; a charging regulator operative in accordance with the first control signal in the standby mode for stabilizing the reference voltage formed by the reference voltage forming section; a sample-and-hold circuit operative in accordance with the second control signal for sampling and holding a power supply voltage corresponding to the reference voltage stabilized by the charging regulator; a buffer section for buffering a power supply voltage fed from the sample-and-hold circuit so as to output the buffered power supply voltage as the reference voltage; and a switch section for, in the standby mode, switching the reference voltage forming section and an output part of the reference voltage forming means into non-conduction, and switching the buffer section and the output part into conduction so as to output the power supply voltage fed from the buffer section as the reference voltage; and wherein the reference voltage forming section performs intermittent operation in accordance with the first control signal formed by the control signal forming section.

Still further, according to another aspect of the present invention, there is provided a semiconductor integrated circuit device wherein the intermittent operation control section further comprises an oscillator circuit for producing a reference clock signal to be fed to the control signal forming section.

Furthermore, according to another aspect of the present invention, there is provided a semiconductor integrated circuit device wherein the intermittent operation control section further comprises a regulator for the oscillator circuit, the regulator being arranged to produce a stepped-down oscillation power supply voltage from an external power supply voltage received from an external circuit and to feed the stepped-down oscillation power supply voltage thus produced to the oscillator circuit.

Moreover, according to another aspect of the present invention, there is provided a semiconductor integrated circuit device wherein the intermittent operation control section further comprises a coupling changeover control section for performing a changeover of the switch section in such a fashion that, in transition from the standby mode to a normal operation mode, after the lapse of a predetermined delay time from when an increase in the reference voltage output from the reference voltage forming section is detected, a switch control signal is output so as to switch the reference voltage forming section and the output part of the reference voltage forming means into conduction, and to switch the buffer section and the output part into non-conduction.

Still further, according to another aspect of the present invention, there is provided a semiconductor integrated circuit device wherein the reference voltage forming section further comprises a function for adjusting the reference voltage at formation thereof by using a trimming signal, and wherein, in the standby mode, the reference voltage forming section does not perform intermittent operation during a reset period that the reference voltage is adjusted by using the trimming signal.

In addition, the other representative aspects of the present invention are as follows.

According to a further aspect of the present invention, there is provided a semiconductor integrated circuit device wherein the reference voltage forming means further comprises a guard ring surrounding the periphery of the reference voltage forming means.

According to an even further aspect of the present invention, there is provided a semiconductor integrated circuit device wherein the reference voltage forming means further comprises a mesh-like metal shield wiring pattern formed to cover the top of the reference voltage forming means.

Enumerated below are advantageous effects to be provided according to the representative aspects of the present invention:

(1) When the semiconductor integrated circuit device is put in the standby mode, the reference voltage forming section requiring a relatively large amount of current consumption is operated intermittently, thereby reducing current consumption significantly.

(2) Further, noise to be generated from the reference voltage forming means can be reduced for enhancement in reliability of the semiconductor integrated circuit device.

### BRIEF DESCRIPTION OF THE DRAWINGS

FIG. 1 is a block diagram showing an exemplary intermittent operation reference voltage generating circuit according to a preferred embodiment 1 of the present invention;

FIG. 2 is a timing chart showing exemplary operations in the intermittent operation reference voltage generating circuit in FIG. 1;

FIG. 3 is an explanatory diagram showing exemplary effects of reducing power consumption by using the intermittent operation reference voltage generating circuit in FIG. 1;

FIG. 4 is an explanatory diagram showing a relationship between an operating waveform and a degree of voltage accuracy at turn-on of external power in the intermittent operation reference voltage generating circuit in FIG. 1;

FIG. 5 is an explanatory diagram showing another relationship, between an operating waveform and a degree of voltage accuracy at turn-on of external power in the intermittent operation reference voltage generating circuit in FIG. 1;

FIG. 6 is an explanatory diagram showing an example of a voltage drop at the time of transition from a standby mode to a normal operation mode in the intermittent operation reference voltage generating circuit in FIG. 1;

FIG. 7 is a state transition diagram of the intermittent operation reference voltage generating circuit in FIG. 1;

FIG. 8 is an explanatory diagram showing an exemplary layout in a semiconductor chip including the intermittent operation reference voltage generating circuit in FIG. 1;

FIG. 9 is an explanatory diagram showing an exemplary layout of the intermittent operation reference voltage generating circuit included in the semiconductor chip in FIG. 8;

FIG. 10 is an explanatory diagram showing an exemplary metal shield wiring pattern formation in the top layered part of the intermittent operation reference voltage generating circuit in FIG. 9;

FIG. 11 is a cross-sectional view taken along line A-B of FIG. 9;

FIG. 12 is an explanatory diagram showing another exemplary metal shield wiring pattern formation in the top layered part of the intermittent operation reference voltage generating circuit in FIG. 9;

FIG. 13 is a cross-sectional view taken along line A-B of FIG. 12;

FIG. 14 is a layout diagram showing an exemplary guard ring formation in the intermittent operation reference voltage generating circuit of FIG. 1 included in the semiconductor chip;

FIG. 15 is a cross-sectional view taken along line A-B of FIG. 14;

FIG. 16 is a block diagram showing another exemplary intermittent operation reference voltage generating circuit according to the preferred embodiment 1 of the present invention;

FIG. 17 is an explanatory diagram showing exemplary effects of reducing power consumption by using the intermittent operation reference voltage generating circuit in FIG. 16;

FIG. 18 is a block diagram showing an exemplary intermittent operation reference voltage generating circuit according to a preferred embodiment 2 of the present invention;

FIG. 19 is an explanatory diagram showing an exemplary layout in a semiconductor chip including the intermittent operation reference voltage generating circuit in FIG. 18;

FIG. 20 is an explanatory diagram showing exemplary effects of reducing power consumption by using the intermittent operation reference voltage generating circuit in FIG. 18;

FIG. 21 is a state transition diagram of the intermittent operation reference voltage generating circuit in FIG. 18;

FIG. 22 is a block diagram showing an exemplary intermittent operation reference voltage generating circuit according to a preferred embodiment 3 of the present invention;

FIG. 23 is a state transition diagram of the intermittent operation reference voltage generating circuit in FIG. 22;

FIG. 24 is an explanatory diagram showing exemplary effects of reducing power consumption by using the intermittent operation reference voltage generating circuit in FIG. 22;

FIG. 25 is a block diagram showing an exemplary intermittent operation reference voltage generating circuit according to a preferred embodiment 4 of the present invention;

FIG. 26 is an explanatory diagram showing exemplary effects of reducing power consumption by using the intermittent operation reference voltage generating circuit in FIG. 25;

FIG. 27 is a circuit diagram showing an exemplary bias circuit provided in the intermittent operation reference voltage generating circuit according to a preferred embodiment 5 of the present invention;

FIG. 28 is a circuit diagram showing an exemplary reference voltage generator circuit provided in the intermittent operation reference voltage generating circuit according to a preferred embodiment 6 of the present invention;

FIG. 29 is a circuit diagram showing an exemplary reference voltage generator circuit provided in the intermittent operation reference voltage generating circuit according to a preferred embodiment 7 of the present invention;

FIG. 30 is a circuit diagram showing an exemplary reference voltage forming circuit provided in the intermittent operation reference voltage generating circuit according to a preferred embodiment 8 of the present invention;

FIG. 31 is a circuit diagram showing an exemplary oscillator circuit provided in the intermittent operation reference voltage generating circuit according to a preferred embodiment 9 of the present invention;

FIG. 32 is a circuit diagram showing an exemplary frequency-division control circuit provided in the intermittent operation reference voltage generating circuit according to a preferred embodiment 10 of the present invention;

FIG. 33 is a timing chart showing exemplary operating waveforms in the frequency-division control circuit in FIG. 32;

FIG. 34 is a circuit diagram showing an exemplary low-accuracy reference circuit provided in the intermittent operation reference voltage generating circuit according to a preferred embodiment 11 of the present invention; and

FIG. 35 is a circuit diagram showing an exemplary coupling delay circuit provided in the intermittent operation reference voltage generating circuit according to a preferred embodiment 11 of the present invention.

### DETAILED DESCRIPTION OF THE PREFERRED EMBODIMENTS

The present invention will now be described in detail by way of example with reference to the accompanying drawings showing the preferred embodiments thereof. Throughout the accompanying drawings, like reference characters designate like or corresponding parts to avoid repetitive description thereof.

### Preferred Embodiment 1

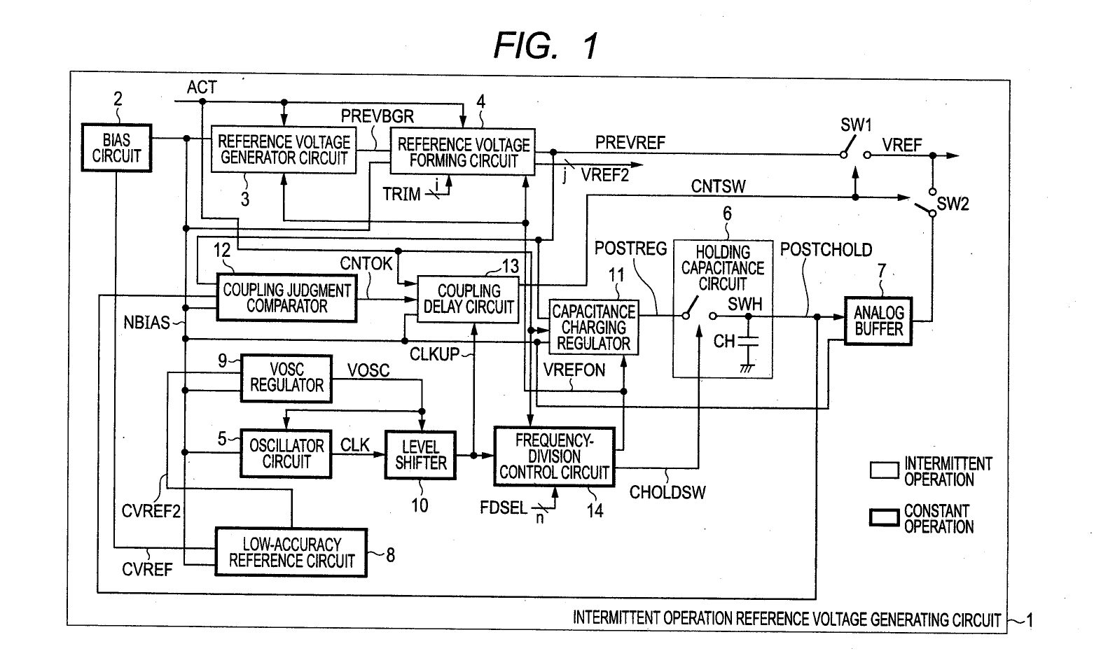

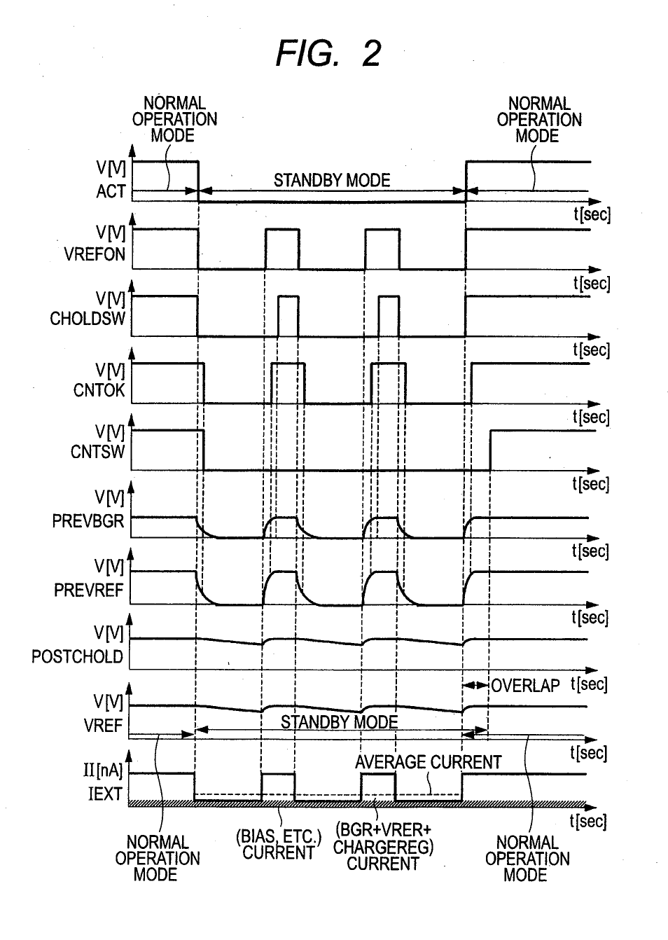

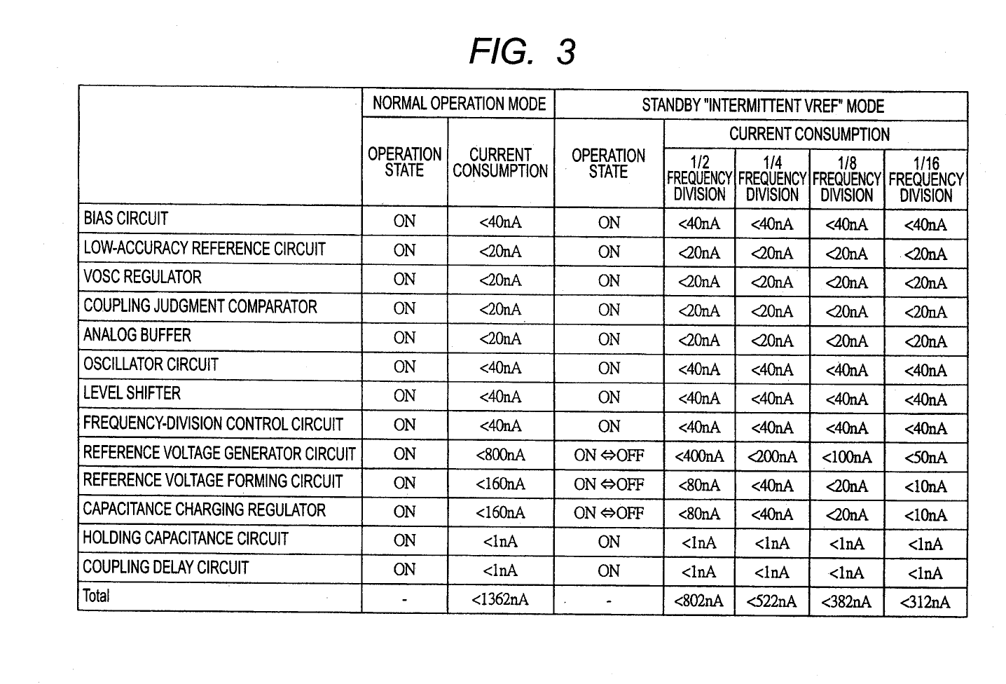

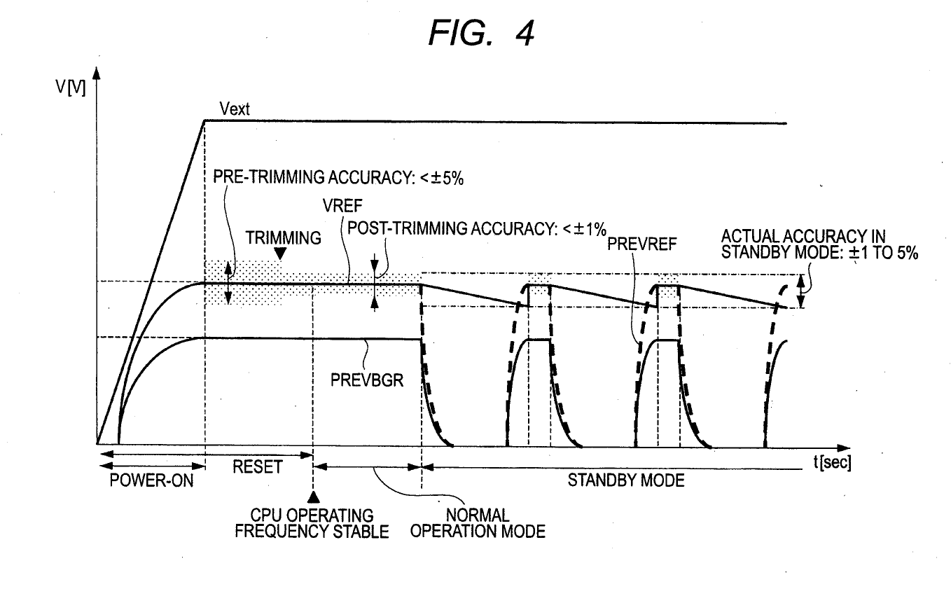

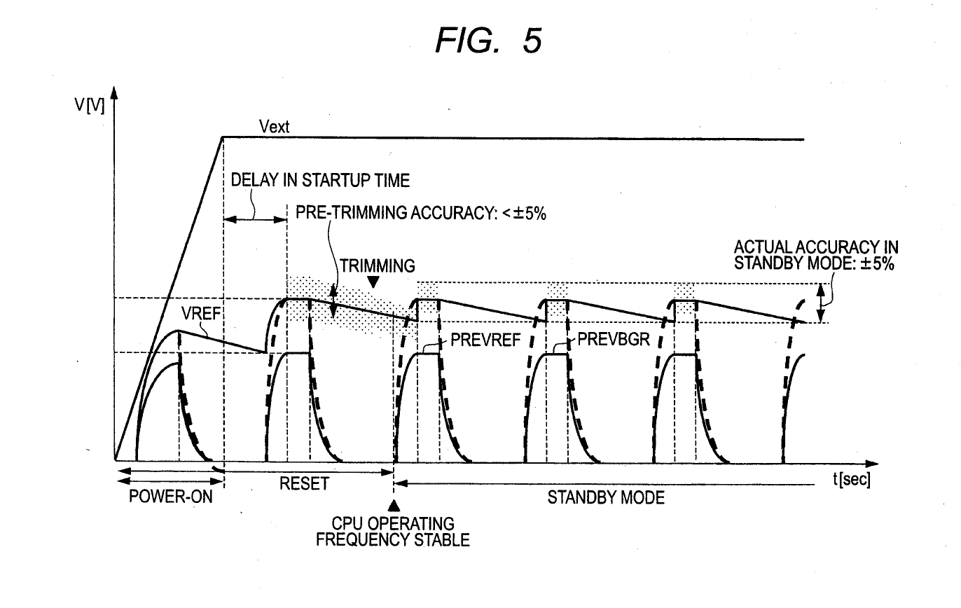

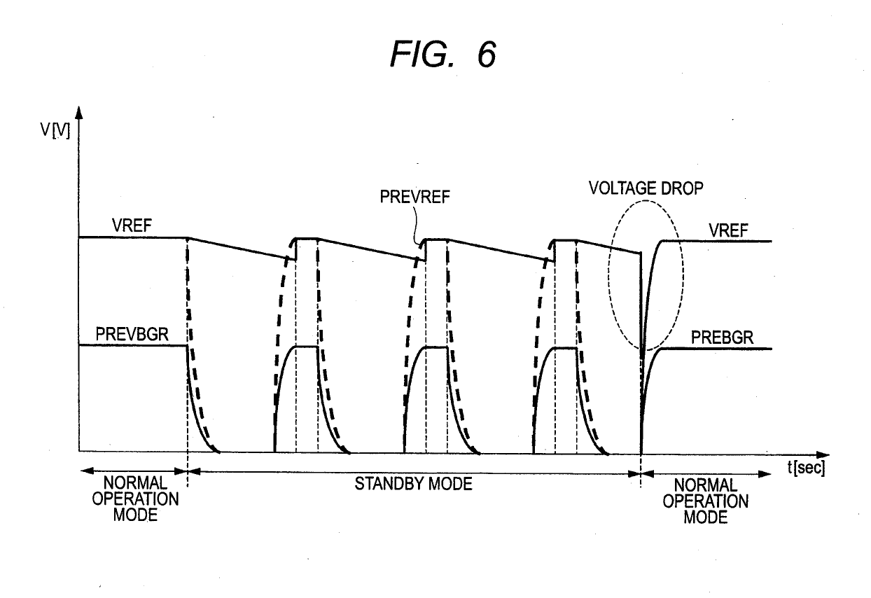

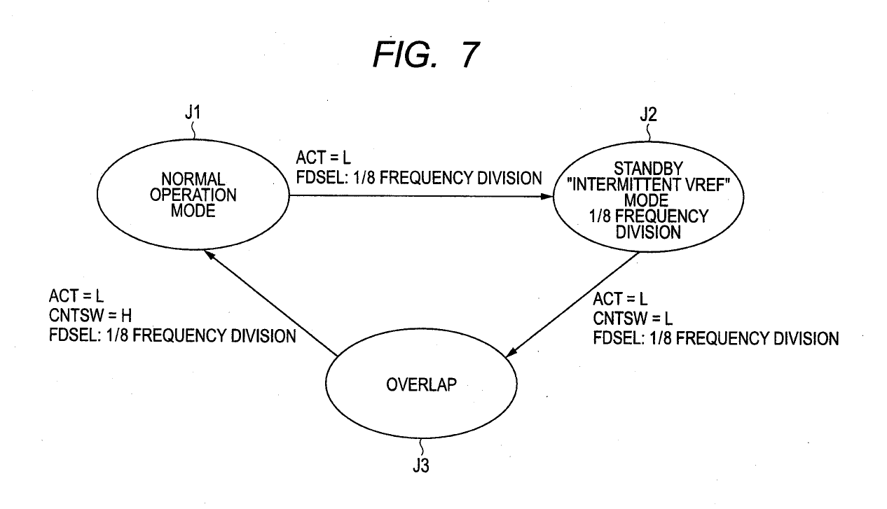

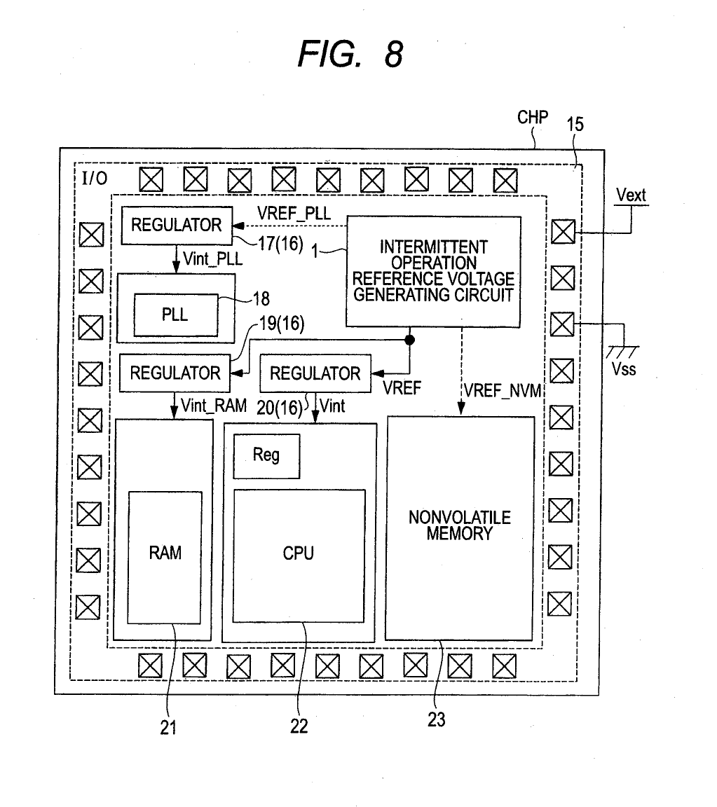

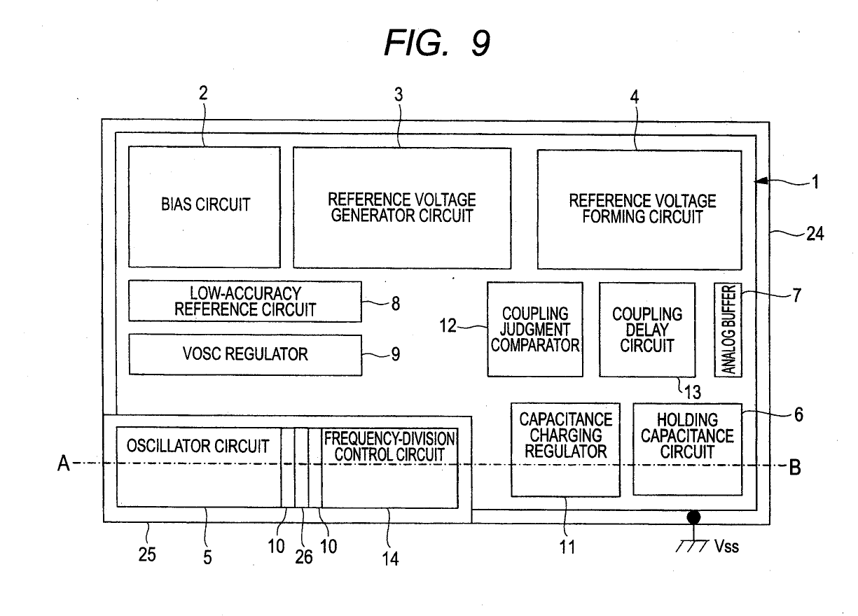

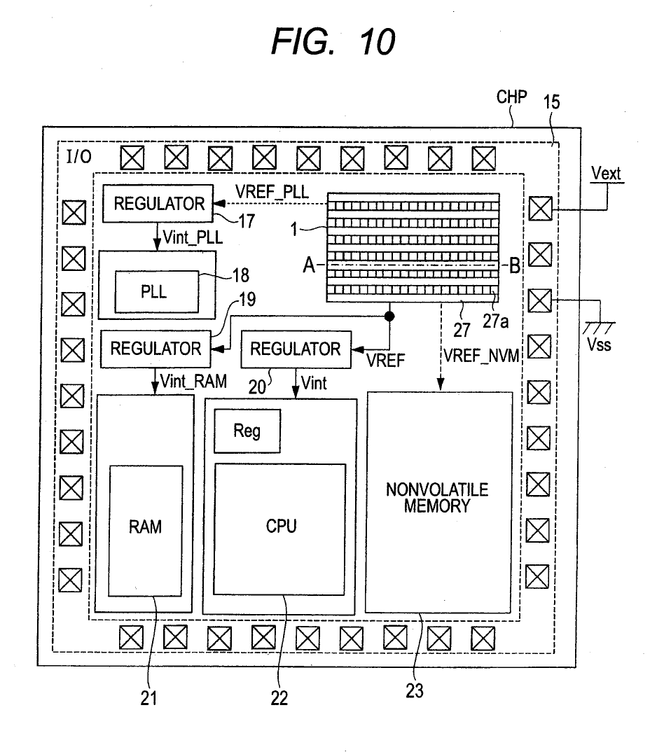

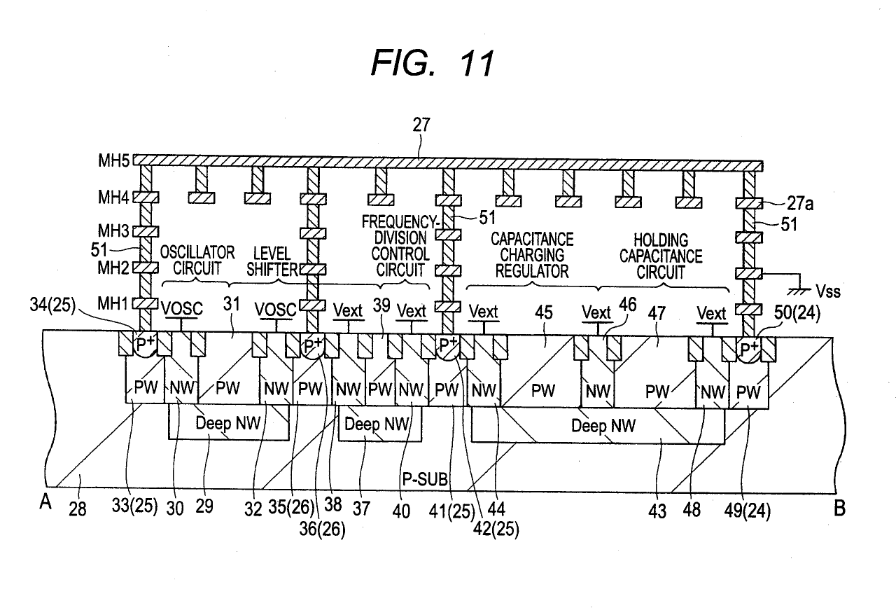

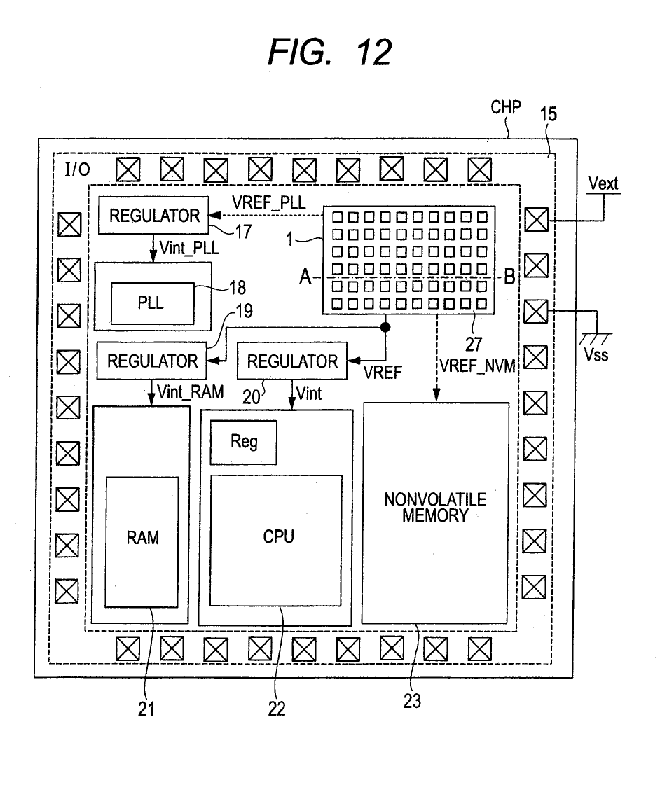

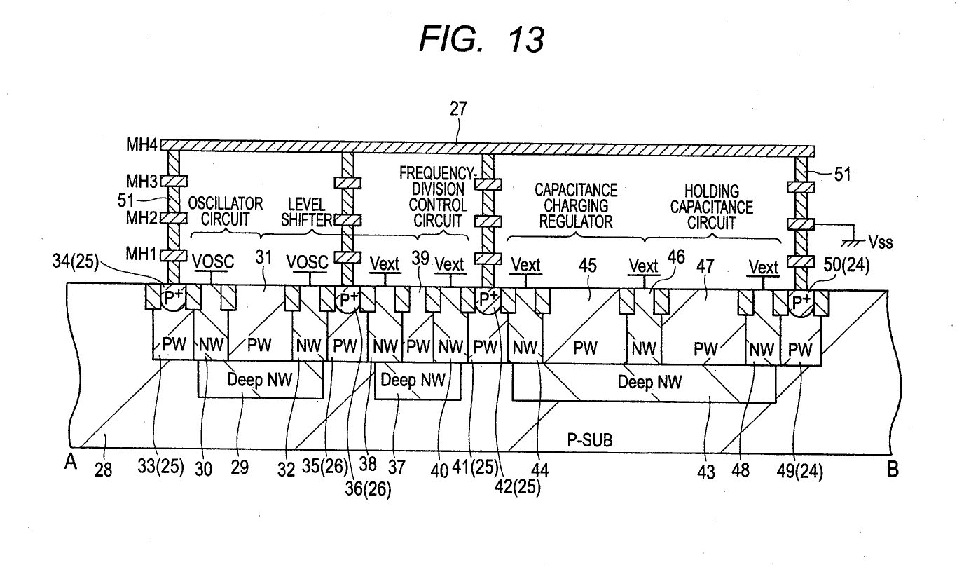

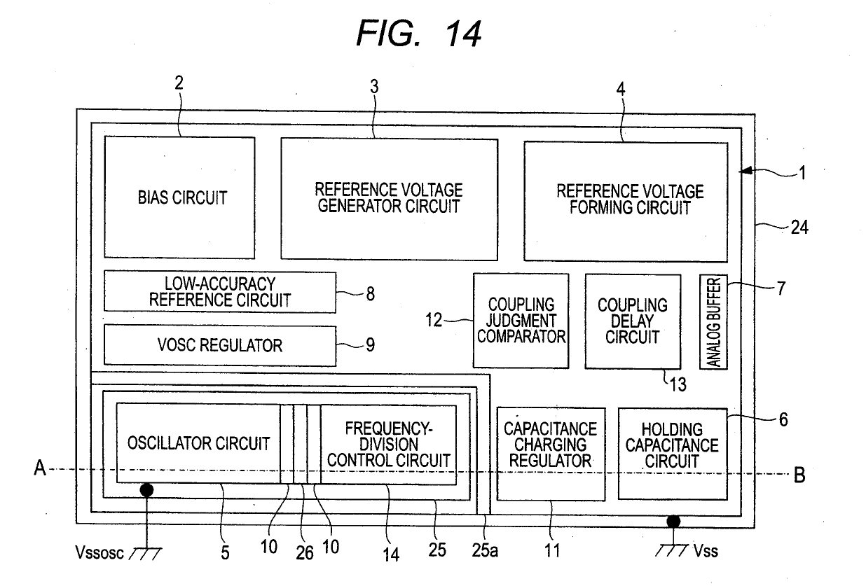

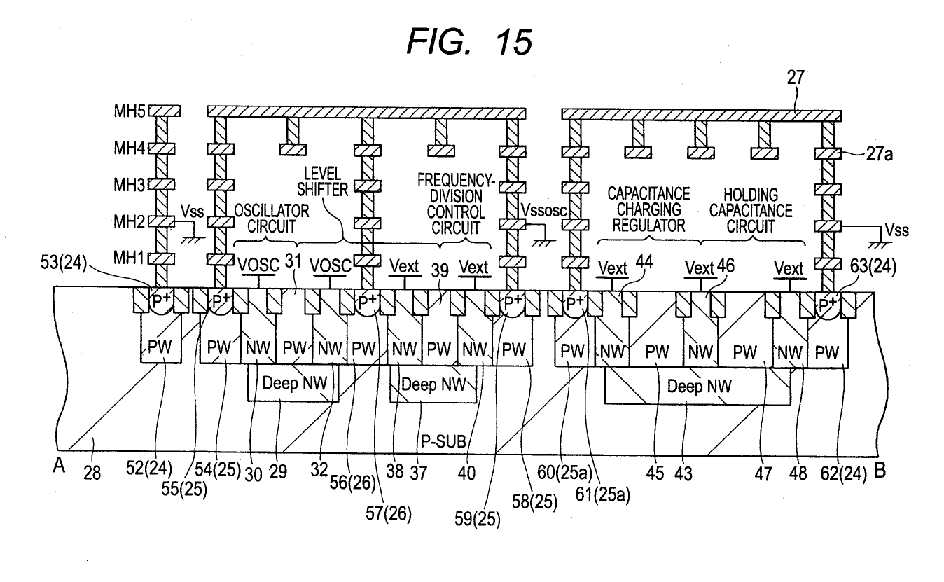

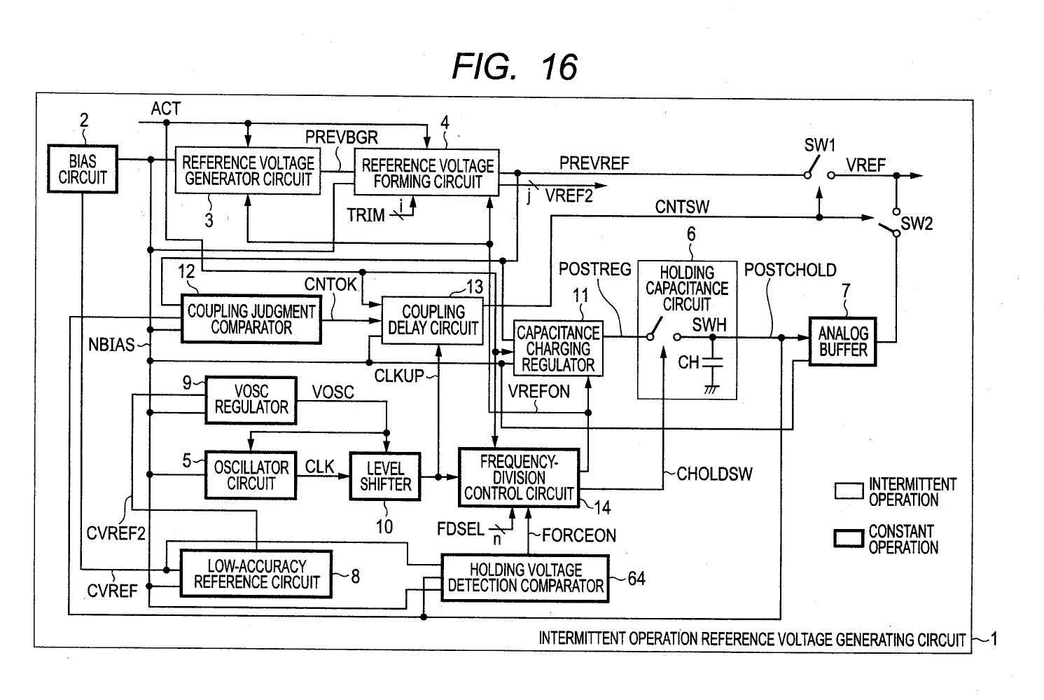

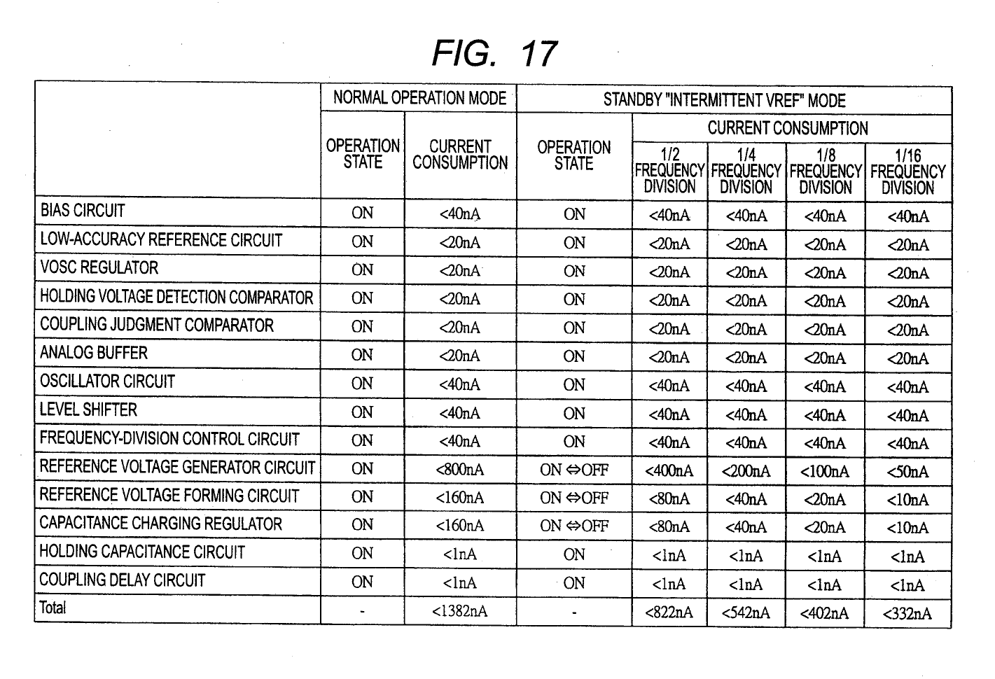

FIG. 1 shows a block diagram of an exemplary intermittent operation reference voltage generating circuit according to a preferred embodiment 1 of the present invention; FIG. 2 shows a timing chart of exemplary operations in the intermittent operation reference voltage generating circuit in FIG. 1; FIG. 3 shows an explanatory diagram of exemplary effects of reducing power consumption by using the intermittent operation reference voltage generating circuit in FIG. 1; FIG. 4 shows an explanatory diagram of a relationship between an operating waveform and a degree of voltage accuracy at turn-on of external power in the intermittent operation reference voltage generating circuit in FIG. 1; FIG. 5 shows an explanatory diagram of another relationship between an operating waveform and a degree of voltage accuracy at turn-on of external power in the intermittent operation reference voltage generating circuit in FIG. 1; FIG. 6 shows an explanatory diagram of an example of a voltage drop at the time of transition from a standby mode to a normal operation mode in the intermittent operation reference voltage generating circuit in FIG. 1; FIG. 7 shows a state transition diagram of the intermittent operation reference voltage generating circuit in FIG. 1; FIG. 8 shows an explanatory diagram of an exemplary layout in a semiconductor chip including the intermittent operation reference voltage generating circuit in FIG. 1; FIG. 9 shows an explanatory diagram of an exemplary layout of the intermittent operation reference voltage generating circuit included in the semiconductor chip in FIG. 8; FIG. 10 shows an explanatory diagram of an exemplary metal shield wiring pattern formation in the top layered part of the intermittent operation reference voltage generating circuit in FIG. 9; FIG. 11 shows a cross-sectional view taken along line A-B of FIG. 9; FIG. 12 shows an explanatory diagram of another exemplary metal shield wiring pattern formation in the top layered part of the intermittent operation reference voltage generating circuit in FIG. 9; FIG. 13 shows a cross-sectional view taken along line A-B of FIG. 12; FIG. 14 shows a layout diagram of an exemplary guard ring formation in the intermittent operation reference voltage generating circuit of FIG. 1 included in the semiconductor chip; FIG. 15 shows a cross-sectional view taken along line A-B of FIG. 14; FIG. 16 shows a block diagram of another exemplary intermittent, operation reference voltage generating circuit according to the preferred embodiment 1 of the present invention; and FIG. 17 shows an explanatory diagram of exemplary effects of reducing power consumption by using the intermittent operation reference voltage generating circuit in FIG. 16.

According to the preferred embodiment 1 of the present invention, an intermitting operation reference voltage generating circuit (IMVREF) 1 is formed in a semiconductor integrated circuit device such as a system-on-chip (SOC) product, for example.

As shown in FIG. 1, the intermittent operation reference voltage generating circuit 1 comprises a bias circuit 2, a reference voltage generator circuit 3, a reference voltage forming circuit 4, an oscillator circuit 5, a holding capacitance circuit 6 serving as a sample-and-hold circuit, an analog buffer 7 serving as a voltage buffer section, a low-accuracy reference circuit 8, a VOSC regulator 9 serving as a regulator for the oscillator circuit, a level shifter 10, a capacitance charging regulator 11 serving as a regulator for charging, a coupling judgment comparator 12 serving as a member configuring a control signal forming section and a coupling changeover control section, a coupling delay circuit 13 serving as a member configuring the control signal forming section and the coupling changeover control section, a frequency-division control circuit 14, and switches SW1 and SW1 serving as members configuring a switch section.

The reference voltage generator circuit 3 and the reference voltage forming circuit 4 are arranged to configure, a reference voltage forming section. The oscillator circuit 5, the holding capacitance circuit 6, the analog buffer 7, the VOSC regulator 9, the capacitance charging regulator 11, the coupling judgment comparator 12, the coupling delay circuit 13, the frequency-division control circuit 14, and the switches SW1 and SW2 are arranged to configure an intermittent operation control section.

In the intermittent operation reference voltage generating circuit 1, the reference voltage generator circuit 3, the reference voltage forming circuit 4, and the capacitance charging regulator 11, which require a relatively large amount of current consumption, are turned ON/OFF intermittently at relatively long time intervals to decrease average self-consumption of current, thereby realizing reduction in current consumption in terms of overall circuit operation (FIG. 2).

In FIG. 1, each of the thick-line boxes indicates a circuit block that performs constant operation regardless of whether the semiconductor integrated circuit device is in the normal operation mode or in the standby operation mode. Each of the thin-line boxes in FIG. 1 indicates a circuit block that performs intermittent operation instead of constant operation when the semiconductor integrated circuit device is in the standby operation mode.

The bias circuit 2 serves as a circuit for determining a constant current to be used by such a component element as an operational amplifier in the intermittent operation reference voltage generating circuit 1. Further, the bias circuit 2 is used to produce an operating voltage for the oscillator circuit 5 and to produce a reference voltage for judgment on an output voltage level of the reference voltage generator circuit 3 or the reference voltage forming circuit 4, albeit with a relatively low degree of voltage accuracy.

In FIG. 1, “NBIAS” indicates a constant-current analog reference signal, and “CVREF” indicates a low-accuracy analog reference voltage signal.

The reference voltage generator circuit 3 produces a reference voltage PREVBGR having less dependency on temperature in the following manner: A voltage (or current) having a positive temperature dependency characteristic is extracted from a potential difference (ΔVbe) with respect to a bipolar transistor base-emitter voltage Vbe due to current density difference, and the voltage (or current) thus extracted is added to a voltage (or current) having a negative temperature dependency characteristic of the bipolar transistor base-emitter voltage Vbe, as indicated by the expression of [Vbgr=Vbe+α×ΔVbe, or Vbgr=Ibgr×R=(Ibe+α×ΔVbe)×R: where α and R are any given values].

In the reference voltage forming circuit 4, the reference voltage PREVBGR is subjected to level conversion to form reference voltages desired in the semiconductor integrated circuit device. For example, the reference voltage forming circuit 4 forms a reference voltage PREVREF that is to be retained in the standby mode as are the cases with an internal power supply voltage Vint for CPU operation and a RAM holding voltage Vint_RAM for regulation, and also forms a reference voltage VREF2 that is not necessarily required to be retained in the standby mode as are the cases with reference voltages to be fed to PLL and ROM circuits (reference voltages VREF PLL and VREF ROM).

It is to be noted that, by using a trimming signal TRIM having “i” bits, the reference voltages PREVREF and VREF2 can be reset and adjusted in the normal operation mode.

The oscillator circuit 5 produces a reference clock signal CLK having a low frequency for intermittent operation. In general terms, frequency variations of the reference clock signal CLK are more sensitive to variations in an operating voltage VOSC of the oscillator circuit 5 itself than to variations in accuracy of a constant current supplied to the oscillator circuit 5 through use of the analog reference signal NBIAS.

Hence, in cases where an external power supply voltage Vext is used as an operating voltage VOSC, stable intermittent operation cannot be achieved due to frequency variations attributable thereto. For reduction in frequency variations, it is therefore necessary to convert an analog reference voltage signal CVREF output from the bias circuit 2 to an approximately twofold voltage level through the low-accuracy reference circuit 8 for producing a reference voltage CVREF2 (=CVREF×2), and then to form an operating voltage VOSC through the VOSC regulator 9 by using the reference voltage CVREF2 thus produced.

Through the level shifter 10, the reference clock signal CLK with reduced frequency variations thereof is converted to a clock signal CLKUP based on the amplitude of the external power supply voltage Vext. Using the clock signal CLKUP thus obtained, an enable signal VREFON and a sampling/holding signal CHOLDSW are formed. The enable signal VREFON is used by the frequency-division control circuit 14 to determine ON/OFF states of the reference voltage generator circuit 3, the reference voltage forming circuit 4, and the capacitance charging regulator 11 in intermittent operation. The sampling/holding signal CHOLDSW is used as a second control signal for performing control so that a holding capacitor CH in the holding capacitance circuit 6 is charged during an ON period of the reference voltage generator circuit 3, the reference voltage forming circuit 4, and the capacitance charging regulator 11 (sampling operation) and so that any paths other than a leak current path are made unavailable to the holding capacitor CH during an OFF period thereof (holding operation).

The frequency-division control circuit 14 is provided with a frequency-division-ratio changeover signal FDSEL having “n” bits for allowing 2ⁿ setting patterns of ON and OFF periods. When a normal/standby state selection signal ACT indicates that the normal operation mode is to be taken, a high-level enable signal VREFON is output.

The analog buffer 7 is used to extract a reference voltage from the holding capacitor CH in the standby mode or at the time of transition from the standby mode to the normal operation mode. To decrease leak current passage other than that via a switch SWH for the holding capacitor CH, the analog buffer 7 is also used as a circuit required for MOS transistor gate input reception.

At the time of transition from the standby mode to the normal operation mode, if an output of the analog buffer 7 is coupled with the reference voltage PREVREF just by changing-over of the normal/standby state selection signal ACT supplied as an external input, an output voltage drop occurs due to a difference in impedance as shown in FIG. 6. For preventing the occurrence of this output voltage drop, the coupling judgment comparator 12 and the coupling delay circuit 13 are used to control the switches SW1 and SW2 so that a changeover between the output of the analog buffer 7 and the reference voltage PREVREF is made after the lapse of a predetermined delay time from when an increase in the reference voltage PREVREF is detected.

Referring to FIG. 2, there is shown a timing chart of examples of representative operating waveforms in the intermittent operation reference voltage generating circuit 1. Since the intermittent operation reference voltage generating circuit 1 as a whole is designed to operate on the external power supply voltage Vext, a high level corresponds to the external power supply voltage Vext and a low level corresponds to a reference potential Vss.

In FIG. 2, the waveforms of the following signals are indicated from top to bottom; normal/standby state selection signal ACT, enable signal VREFON used as a first control signal, sampling/holding signal CHOLDSW, output voltage increase/decrease detection signal CNTOK fed from the coupling judgment comparator 12 upon detection of an increase/decrease in an output voltage of the reference voltage generator circuit 3 or the reference voltage forming circuit 4, reference changeover signal CNTSW fed from the coupling delay circuit 13 at the time of transition from the standby mode to the normal operation mode, reference voltage PREVBGR, reference voltage PREVREF, reference holding capacitance voltage POSTCHOLD of the holding capacitance circuit 6, reference voltage VREF output from the intermittent operation reference voltage generating circuit 1, and self-consumed current IEXT in the intermittent operation reference voltage generating circuit 1.

In the normal operation mode, the reference voltage PREVREF produced by the reference voltage generator circuit 3 and the reference voltage forming circuit 4 is steadily output from the intermittent operation reference voltage generating circuit 1, thereby providing a stable reference potential free from voltage variations.

In the standby mode, for an ON period of the reference voltage generator circuit 3 and the reference voltage forming circuit 4, the reference voltage VREF remains at the same level as that in the normal operation mode. Contrastingly, during an OFF period of the reference voltage generator circuit 3 and the reference voltage forming circuit 4, the switch SWH and the holding capacitor CH in particular are discharged due to current leakage from MOS transistors (caused by junction leakage, subthreshold leakage, gate leakage, etc.), resulting in a decrease in the level of the reference voltage VREF.

In consequence, the reference voltage VREF has a voltage-rippling waveform for a period of the standby mode. For reducing a decrease in the level of the reference voltage VREF, it is effective to shorten an OFF period of the reference voltage generator circuit 3 and the reference voltage forming circuit 4. However, shortening the OFF period thereof will lead to diminution of the effectiveness of reduction in current consumption. It is therefore necessary to determine an optimum value of the OFF period thereof in accordance with particular operating environment conditions, fabrication processes, and product specifications of the semiconductor integrated circuit device concerned.

As shown in FIG. 2, there is provided an overlap period that the states of the standby mode and the normal operation mode are overlapped with each other at the time of transition from the standby mode to the normal operation mode, thus contributing to reduction in the degree of voltage dropping at the transition. In the standby mode, the high-level period of the sampling/holding signal CHOLDSW is set up in correspondence with the latter half of the high-level period of the enable signal VREFON for the following reason: At the instant when the enable signal VREFON goes high, the reference voltage generator circuit 3, the reference voltage forming circuit 4, and the capacitance charging regulator 11 are turned ON. However, in a transient state to a proper bias condition that allows supplying a stable output voltage from the intermittent operation reference voltage generating circuit 1, an output voltage overshooting or ringing is prone to occur in general terms. Hence, the high-level period of the sampling/holding signal CHOLDSW is set up at such a timing that a voltage is applied to the holding capacitor CH under the condition that the stability thereof is ensured.

Referring to FIG. 3, there is shown an explanatory diagram of exemplary effects of reducing current consumption in the intermittent operation reference voltage generating circuit 1.

In the normal operation mode, all the circuit modules included in the intermittent operation reference voltage generating circuit 1 are turned ON to bring about a sum total of approximately 1362 nA in current consumption under the conditions that the external power supply voltage Vext is approximately 3.3 V and the ambient temperature is approximately 27° C. Contrastingly, in an instance where a frequency division ratio of 1/8 is selected by the frequency-division-ratio changeover signal FDSEL in the standby mode, the sum total of current consumption is approximately 382 nA, which signifies a reduction of approximately 72% in current consumption as compared with that in the normal operation mode.

Referring to FIG. 4, there is shown an explanatory diagram of an exemplary relationship between an operating waveform at turn-on of the external power supply voltage Vext to the semiconductor integrated circuit device including the intermittent operation reference voltage generating circuit 1 and a degree of voltage accuracy before/after trimming is performed by the reference voltage forming circuit 4.

At power-on, the semiconductor integrated circuit device is put in a reset state, waiting until the internal power supply voltage Vint and the CPU operating frequency become stable.

During the reset period, the intermittent operation reference voltage generating circuit 1 performs trimming according to nonvolatile memory information predetermined for optimizing the internal power supply voltage Vint based on result data of individual chip inspection prior to product shipment.

As shown in FIG. 4, for example, the value of pre-trimming accuracy is within the range of ±5%, which is determined depending on absolute accuracy values and relative accuracy variations of semiconductor elements such as CMOS transistors, resistors, and parasitic bipolar transistors contained in the reference voltage generator circuit 3 and the reference voltage forming circuit 4. By way of contrast, the value of post-trimming accuracy is within the range of ±1%, for example.

Hence, in the normal operation mode, a post-trimming accuracy of ±1%, for example, is obtained for the reference voltages VREF and VREF2. In the standby mode, while the reference voltage generator circuit 3 and the reference voltage forming circuit 4 are turned ON, the value of post-trimming accuracy is within the range of ±1%, for example, which is the same as that in the normal operation mode. Contrastingly, while the reference voltage generator circuit 3 and the reference voltage forming circuit 4 are turned OFF in the standby mode, there occurs a decrease in voltage level due to current leakage. Consequently, the degree of actual accuracy in the standby mode is degraded as compared with the post-trimming accuracy of ±1%, for example.

Since the degradation in voltage accuracy due to current leakage depends on such factors as operating environment conditions and fabrication processes of the semiconductor integrated circuit device, the degree of actual accuracy is adjusted according to the ON and OFF periods of the reference voltage generator circuit 3 and the reference voltage forming circuit 4 with reference to product specification data of current consumption, lower-limit data of RAM holding voltage in the standby mode, and the like. As an example in FIG. 4, the value of actual accuracy is determined to be within the range of ±1 to 5%.

Regarding the reset period of the semiconductor integrated circuit device, the following will examine whether the reference voltage generator circuit 3 and the reference voltage forming circuit 4 included in the intermittent operation reference voltage generating circuit 1 are to be kept ON at all times as in the normal operation mode or to be turned ON/OFF intermittently as in the standby mode. If an intermittent ON/OFF operation is performed during the reset period as shown in FIG. 5, a delay in startup time occurs due to a duration of an OFF period for low current consumption, resulting in the reset period being prolonged. Further, since there occurs a decrease in voltage level due to current leakage as described above, it becomes impossible to perform trimming under the condition that the reference voltages PREVBGR and PREVREF are adequately stable, causing insufficient improvement in post-trimming accuracy (e.g., ±5%).

It is therefore required that the reference voltage generator circuit 3 and the reference voltage forming circuit 4 be kept ON at all times for the reset period. It seems that post-trimming accuracy may be improved through reduction in degradation due to current leakage by shortening an OFF period in intermittent operation during the rest period (by using a frequency division ratio of 1/2, for example). However, since an adverse effect of voltage rippling is not completely negligible, a degree of voltage accuracy as high as that achievable in a continuous ON state cannot be obtained by shortening the OFF period as mentioned above.

Referring to FIG. 7, there is shown an explanatory diagram of an exemplary state transition in the intermittent operation reference voltage generating circuit 1.

During the above-mentioned reset period of the semiconductor integrated circuit device, the intermittent operation reference voltage generating circuit 1 is put in a normal state J1. In addition, there are provided a standby state J2 and an overlap state J3 in which a transition is made from the standby mode to the normal operation mode.

Referring to FIG. 8, there is shown an explanatory diagram of an exemplary layout in a semiconductor chip CHP corresponding to the semiconductor integrated circuit device including the intermittent operation reference voltage generating circuit 1.

The semiconductor chip CHP having a square shape is provided with an I/O region 15 laid out along the four peripheral sides thereof. The intermittent operation reference voltage generating circuit 1 is laid out at the upper right position inward from the I/O region 15.

A regulator 17 is laid out at the left side of the intermittent operation reference voltage generating circuit 1, and a PLL circuit 18 is laid out at the lower side of the regulator 17. Further, a regulator 19 is laid out at the lower side of the PLL circuit 18, and a regulator 20 is laid out at the right side of the regulator 19.

The intermittent operation reference voltage generating circuit 1, and the regulators 17, 19 and 20 are arranged to configure a system power supply circuit 16.

Furthermore, a RAM 21 is laid out at the lower side of the regulator 19, and a CPU 22 is laid out at the right side of the RAM 21. Still further, a nonvolatile memory 23, which is demonstratively represented by a flash memory, is laid out at the right side of the CPU 22.

In the layout arrangement mentioned above, through the regulators 17, 19 and 20, the external power supply voltage Vext is stepped down to lower potentials including internal power supply voltages Vint, Vint_RAM and Vint_PLL to be furnished to such internal circuits as the RAM 21, CPU 22 and PLL circuit 18.

In addition, a lower potential stepped down from the external power supply voltage Vext is also furnished as a reference voltage VREF_NVM to a positive/negative charge pump circuit provided as a peripheral circuit for the nonvolatile memory 23, for example.

Referring to FIG. 9, there is shown an explanatory diagram of an exemplary layout of the intermitted operation reference voltage generating circuit 1 included in the semiconductor chip CHP in FIG. 8.

As shown in FIG. 9, the bias circuit 2 is laid out at the upper left position in the intermittent operation reference voltage generating circuit 1, and the reference voltage generator circuit 3 is laid out at the right side of the bias circuit 2. The reference voltage forming circuit 4 is laid out at the right side of the reference voltage generator circuit 3.

The low-accuracy reference circuit 8 is laid out at the lower side of the bias circuit 2 and the reference voltage generator circuit 3, and the VOSC regulator 9 is laid out at the lower side of the low-accuracy reference circuit 8.

The coupling judgment comparator 12 is laid out at the right side of the low-accuracy reference circuit 8 and the VOSC regulator 9, and the coupling delay circuit 13 is laid out at the right side of the coupling judgment comparator 12.

The analog buffer 7 is laid out at the right side of the coupling delay circuit 13. The holding capacitance circuit 6 is laid out at the lower side of the coupling delay circuit 13 and the analog buffer 7, and the capacitance charging regulator 11 is laid out at the left side of the holding capacitance circuit 6. The frequency-division control circuit 14 is laid out at the left side of the capacitance charging regulator 11, and the oscillator circuit 5 is laid out at the left side of the frequency-division control circuit 14.

Outside the layout position of the intermittent operation reference voltage generating circuit 1, a guard ring 24 is so formed as to surround the intermittent operation reference voltage generating circuit 1. Outside the frequency-division control circuit 14, level shifter 10, and oscillator circuit 5, a guard ring 25 is so formed as to surround the frequency-division control circuit 14, level shifter 10, and oscillator circuit 5.

Further, a guard ring 26 is formed in an interposed fashion between two portions of the level shifter 10. Each of the guard rings 24, 25 and 26 thus formed is supplied with the reference potential Vss.

In the intermittent operation reference voltage generating circuit 1, the oscillator circuit 5 produces the reference clock signal CLK to be used for intermittent operation. Through the level shifter 10, the reference clock signal CLK is applied to the frequency-division control circuit 14 for carrying out frequency dividing operation and waveform control. In the oscillator circuit 5, level shifter 10, and frequency-division control circuit 14, CMOS logic circuit switching may cause generation of noise.

To suppress switching noise propagation to such circuits to be protected against noise as the bias circuit 2 and the reference voltage generator circuit 3, the guard rings 25 and 26 supplied with the reference potential Vss are provided for protection against such possible noise sources as the oscillator circuit 5, level shifter 10, and frequency-division control circuit 14.

Further, since the guard ring 24 is so formed as to surround the intermittent operation reference voltage generating circuit 1 as mentioned above, internal circuits disposed in the vicinity of the intermittent operation reference voltage generating circuit 1 are protected against adverse effect due to switching noise propagation.

Furthermore, in the top layered part of the intermittent operation reference voltage generating circuit 1, metal shield wiring patterns 27 and 27a are formed as shown in FIG. 10. The metal shield wiring pattern 27 is disposed orthogonally to the metal shield wiring pattern 27a to provide a mesh-like form.

Since the top of the intermittent operation reference voltage generating circuit 1 is covered with the metal shield wiring patterns 27 and 27a, the outward propagation of possible noise from the inside of the intermittent operation reference voltage generating circuit 1 can be prevented, and also the degree of adverse effect due to external noise can be reduced to protect the inside of the intermittent operation reference voltage generating circuit 1.

Referring to FIG. 11, there is shown a cross-sectional view taken along the line A-B indicated in FIG. 9 (FIG. 10).

As shown in FIG. 11, for example, a DEEP-NWELL region 29 is formed in the upper left part of a p-type semiconductor substrate 28. At the upper position of the DEEP-NWELL 29, an NWELL region 30, a PWELL region 31, and an NWELL region 32 are formed from left to right.

At the left side position of the NWELL region 30, the guard ring 25 is formed which comprises a PWELL region 33 formed in the upper part of the semiconductor substrate 28 and a p+ semiconductor region 34 formed in the upper portion of the PWELL region 33. The p+ semiconductor region 34 is a region having a higher impurity concentration than that of the PWELL region 33.

At the right position of the NWELL region 32, the guard ring 26 is formed which comprises a PWELL region 35 formed in the upper part of the semiconductor substrate 28 and a p+ semiconductor region 36 formed in the upper portion of the PWELL region 35.

A DEEP-NWELL region 37 is formed at the lower right position of the guard ring 26. At the upper position of the DEEP-NWELL region 37, an NWELL region 38, a PWELL region 39, and an NWELL region 40 are formed from left to right.

At the right position of the NWELL region 40, the guard ring 25 is formed which comprises a PWELL region 41 formed in the upper part of the semiconductor substrate 28 and a p+ semiconductor region 42 formed in the upper portion of the PWELL region 41.

A DEEP-NWELL region 43 is formed at the lower right position of the guard ring 25. At the upper position of the DEEP-NWELL region 43, an NWELL region 44, a PWELL region 45, an NWELL region 46, a PWELL region 47, and an NWELL region 48 are formed from left to right.

At the right position of the NWELL region 48, the guard ring 24 is formed which comprises a PWELL region 49 formed in the upper part of the semiconductor substrate 28 and a p+ semiconductor region 50 formed in the upper portion of the PWELL region 49.

The NWELL region 30 and a part of the PWELL region 31 are used as a semiconductor element forming region where semiconductor elements configuring the oscillator circuit 5 are formed. The remaining part of the PWELL region 31, the NWELL region 38, and a part the PWELL region 39 are used as a semiconductor element forming region where semiconductor elements configuring the level shifter 10 are formed.

The remaining part of the PWELL region 39 and the NWELL region 40 are used as a semiconductor element forming region where semiconductor elements configuring the frequency-division control circuit 14 are formed. The NWELL region 44, the PWELL region 45, and a part of the NWELL region 46 are used as a semiconductor element forming region where semiconductor elements configuring the capacitance charging regulator 11 are formed.

The remaining part of the NWELL region 46, the PWELL region 47, and the NWELL region 48 are used as a semiconductor element forming region where semiconductor elements configuring the holding capacitance circuit 6 are formed.

Through a via hole 51, p+ semiconductor regions 34, 36, 42 and 50 are coupled to the metal shield wiring pattern 27a formed in a fourth wiring layer MH4 (one of wiring layers MH1 to MH5) and also coupled to the metal shield wiring pattern 27 formed in a fifth wiring layer MH5 located over the wiring layer MH4.

The metal shield wiring patterns 27 and 27a are supplied with the reference potential Vss. As described above, the metal shield wiring patterns 27 and 27a are disposed orthogonally to each other to provide a mesh-like form.

In lieu of the arrangement in which the metal shield wiring patterns 27 and 27a are formed in the fifth and fourth wiring layers MH5 and MH4 respectively, a meshed metal shield wiring pattern 27 may be formed in one wiring layer as shown in FIG. 12.

In this case, as shown in FIG. 13, the meshed metal shield wiring pattern 27 is disposed in the fourth wiring layer MH4, and the reference potential Vss is supplied to the meshed metal shield wiring pattern 27 in the fourth wiring layer MH4. The other cross-sectional arrangements shown in FIG. 13 are similar to those shown in FIG. 11, and no repetitive description thereof is given here.

Further, there may also be provided a modified formation of guard rings as exemplified in FIG. 14. In the guard ring formation shown in FIG. 14, a guard ring 24 outside the layout position of the intermittent operation reference voltage generating circuit 1 is so formed as to entirely surround the intermittent operation reference voltage generating circuit 1. A guard ring 25 is so formed as to surround the oscillator circuit 5, the level shifter 10, and the frequency-division control circuit 14. A guard ring 26 is formed in an interposed fashion between two portions of the level shifter 10, and a guard ring 25a is formed around the periphery of the guard ring 25. Thus, the oscillator circuit 5, the level shifter 10, and the frequency-division control circuit 14 are provided with double guard ring enclosure.

The guard rings 24 and 25a are supplied with the reference potential Vss, and the guard rings 25 and 26 are supplied with a reference potential Vssosc that is used as a reference potential for the oscillator circuit 5. Thus, the degree of adverse effect due to noise can be reduced more effectively.

Referring to FIG. 15, there is shown a cross-sectional view taken along the line A-B indicated in FIG. 14.

As shown in FIG. 15, a DEEP-NWELL region 29 is formed in the upper left part of a p-type semiconductor substrate 28. At the upper left position of the DEEP-NWELL region 29, the guard ring 24 is formed which comprises a PWELL region 52 and a p+ semiconductor region 53 formed in the upper portion of the PWELL region 52. The guard ring 24 thus formed is supplied with the reference potential Vss.

At the right position of the guard ring 24, the guard ring 25 is formed which comprises a PWELL region 54 and a p+ semiconductor region 55 formed in the upper portion of the PWELL region 54. The guard ring 25 is supplied with the reference potential Vssosc.

At the right position across an NWELL region 30, a PWELL region 31, and an NWELL region 32 from the guard ring 25, the guard ring 26 supplied with the reference potential Vssosc is formed. The guard ring 26 comprises a PWELL 56 formed in the upper part of the semiconductor substrate 28 and a p+ semiconductor region 57 formed in the upper portion of the PWELL region 56.

At the right position across an NWELL region 38, a PWELL region 39, and an NWELL region 40 from the guard ring 26, the guard ring 25 is formed. The guard ring 25 comprises a PWELL region 58 formed in the upper part of the semiconductor substrate 28 and a p+ semiconductor region 59 formed in the upper portion of the PWELL region 58.

At the right position of the guard ring 25, the guard ring 25a supplied with the reference potential Vss is formed. The guard ring 25a comprises a PWELL region 60 formed in the upper part of the semiconductor substrate 28 and a p+ semiconductor region 61 formed in the upper portion of the PWELL region 60.

At the right position across an NWELL region 44, a PWELL region 45, an NWELL region 46, a PWELL region 47, and an NWELL region 48 from the guard ring 25a, the guard ring 24 is formed. The guard ring 24 comprises a PWELL region 62 formed in the upper part of the semiconductor substrate 28 and a p+ semiconductor region 63 formed in the upper portion of the PWELL region 62.

Referring to FIG. 16, there is shown a block diagram of an exemplary configuration wherein a holding voltage detection comparator 64 is additionally provided in the configuration of the intermittent operation reference voltage generating circuit 1 of FIG. 1.

The holding voltage detection comparator 64 performs voltage level comparison between the low-accuracy analog reference voltage signal CVREF produced by the bias circuit 2 and the reference holding capacitance voltage POSTCHOLD of the holding capacitor CH in the holding capacitance circuit 6. If the level of the reference holding capacitance voltage POSTCHOLD is lower than that of the analog reference voltage signal CVREF, a polar signal FORCEON is inverted to forcedly turn ON the reference voltage generator circuit 3, the reference voltage forming circuit 4, and the capacitance charging regulator 11.

More specifically, in either of the normal operation mode and the standby mode, if the holding voltage detection comparator 64 judges that the level of the reference holding capacitance voltage POSTCHOLD of the holding capacitor CH is lower than that of the analog reference voltage signal CVREF, the reference voltage level of the internal power supply voltage Vint is restored to a predetermined operating voltage level before a decrease in the internal power supply voltage Vint due to any cause inside/outside the semiconductor chip CHP brings about an undefined logic state in internal circuit operations. Regarding current consumption in the configuration shown in FIG. 16, the amount of current consumed by the holding voltage detection comparator 64 is added as shown in FIG. 17.

The low-accuracy analog reference voltage signal CVREF has a voltage level higher than a threshold level Vthp of a PMOS transistor used in a CMOS circuit included in such an internal circuit as the CPU 22, a threshold level Vthn of an NMOS transistor used therein, or the sum of values of these threshold levels (Vthp+Vthn). Hence, the analog reference voltage signal CVREF is applicable as a criterion for judging whether an undefined logic state is involved in internal circuit logic operations.

As described above and according to the preferred embodiment 1 of the present invention, current consumption can be reduced significantly by intermittently turning ON/OFF the reference voltage generator circuit 3, the reference voltage forming circuit 4, and the capacitance charging regulator 11, each of which would otherwise consume a relatively large amount of current for operation thereof.

### Preferred Embodiment 2

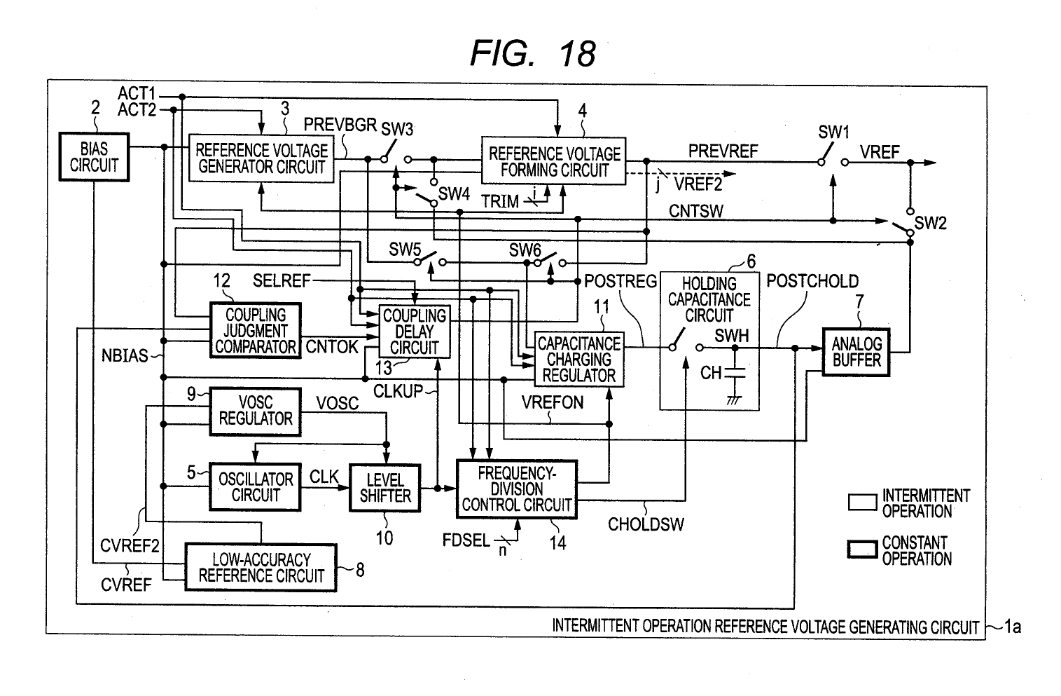

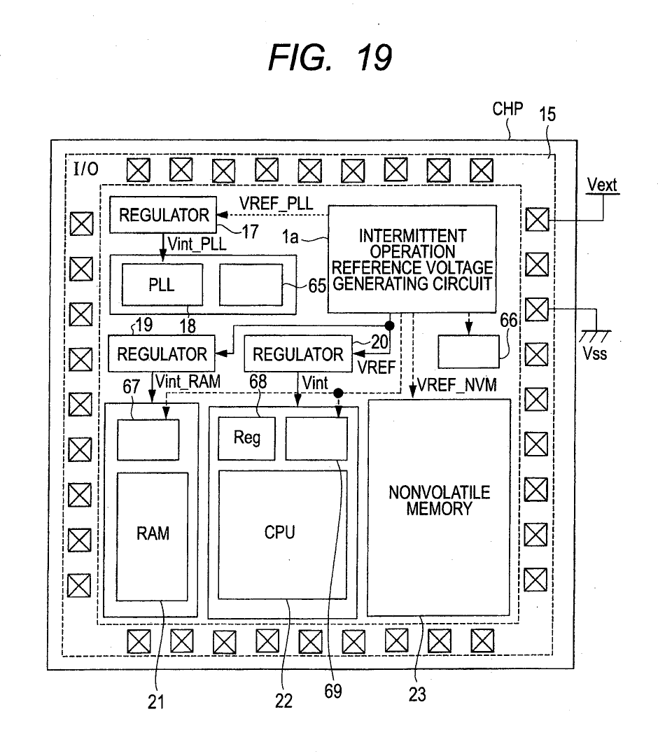

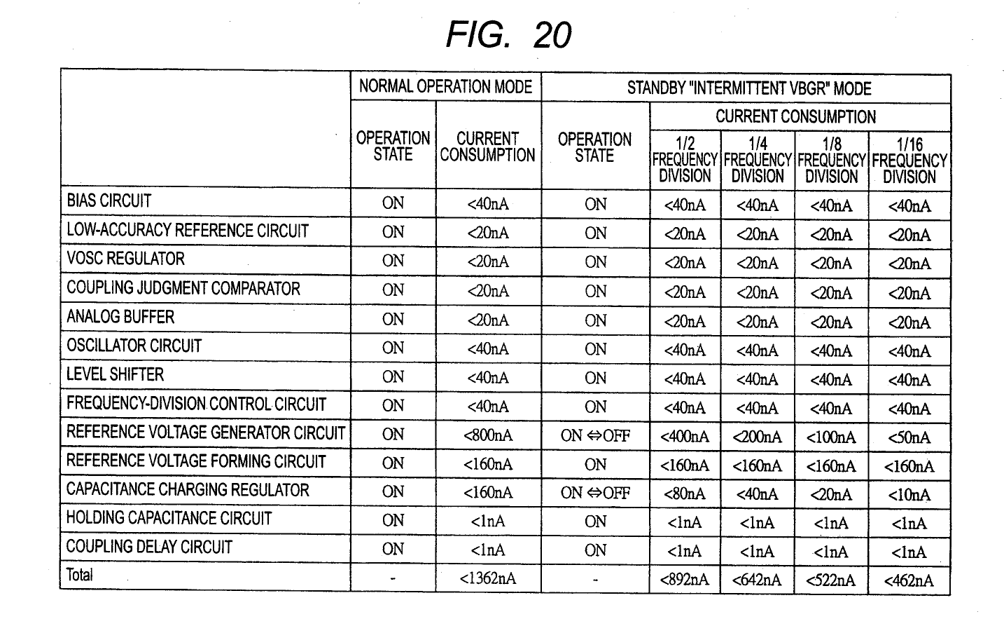

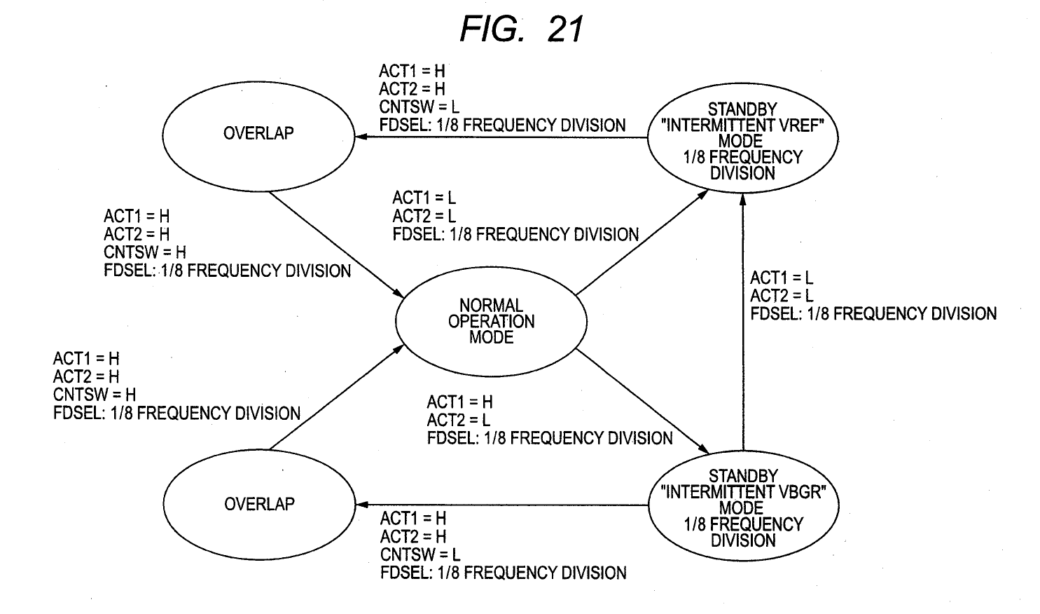

FIG. 18 shows a block diagram of an exemplary intermittent operation reference voltage generating circuit according to a preferred embodiment 2 of the present invention; FIG. 19 shows an explanatory diagram of an exemplary layout in a semiconductor chip including the intermittent operation reference voltage generating circuit in FIG. 18; FIG. 20 shows an explanatory diagram of exemplary effects of reducing power consumption by using the intermittent operation reference voltage generating circuit in FIG. 18; and FIG. 21 shows a state transition diagram of the intermittent operation reference voltage generating circuit in FIG. 18.

According to the preferred embodiment 2 of the present invention, an intermittent operation reference voltage generating circuit 1a shown in FIG. 18 is configured to have an arrangement wherein there are additionally provided switches SW3 to SW6 in the configuration of the foregoing preferred embodiment 1 of the present invention shown in FIG. 1. In the configuration shown in FIG. 1, the switches SW1 and SW2 for reference changeover are used to select the reference voltage PREVREF fed from the reference voltage forming circuit 4 or the output of the analog buffer 7 as a reference voltage VREF according to the reference changeover signal CNTSW fed from the coupling delay circuit 13.

By way of contrast, in the configuration shown in FIG. 18, the reference voltage PREVBGR fed from the reference voltage generator circuit 3 or the reference voltage PREVREF fed from the reference voltage forming circuit 4 is held in the holding capacitor CH by using the switches SW3 to SW6 for reference changeover according to normal/standby state selection signals ACT1 and ACT2.

Thus, there are provided two standby modes; a standby “intermittent VREF” mode, and a standby “intermittent VBGR” mode. In the standby “intermittent VREF” mode, both the reference voltage generator circuit 3 and the reference voltage forming circuit 4 are turned ON/OFF intermittently. In the standby “intermittent VBGR” mode, only the reference voltage generator 3 is turned ON/OFF intermittently whereas the reference voltage forming circuit 4 is kept ON at all times.

In the intermittent operation reference voltage generating circuit 1a configured as mentioned above, the reference voltage VREF2 is applicable without capacitance holding even in standby operation.

Referring to FIG. 19, there is shown an explanatory diagram of an exemplary layout in a semiconductor chip CHP corresponding to the semiconductor integrated circuit device including the intermittent operation reference voltage generating circuit 1a.

The semiconductor chip CHP having a square shape is provided with an I/O region 15 laid out along the four peripheral sides thereof. The intermittent operation reference voltage generating circuit 1a is laid out at the upper right position inward from the I/O region 15.

A regulator 17 is laid out at the left side of the intermittent operation reference voltage generating circuit la, and a PLL circuit 18 is laid out at the lower side of the regulator 17. Further, a low voltage detection circuit 65 (LVD3) is laid out at the right side of the PLL circuit 8.

A regulator 19 is laid out at the lower side of the PLL circuit 18, and a regulator 20 is laid out at the right side of the regulator 19. Further, a low voltage detection circuit 66 (LVD4) is laid out at the right side of the regulator 20.

A low voltage detection circuit 67 (LVD1) is laid out at the lower side of the regulator 19, and a RAM 21 is laid out at the lower side of the low voltage detection circuit 67. At the right side of the RAM 21, a CPU 22 is laid out.

A register 68 and a low voltage detection circuit 69 (LVD2) are laid out at the upper side of the CPU 22, and a nonvolatile memory 23 is laid out at the right side of the CPU 22.

In the configuration shown in FIG. 19, a decrease in the internal power supply voltages used inside the semiconductor chip CHP (Vint, Vint_RAM, Vint_PLL) and a decrease in the external power supply voltage (Vext) can be detected by the low voltage detection circuits 65, 66, 67, and 69 in the normal operation mode, and also in the standby mode, albeit with a lower degree of voltage accuracy than that in normal operation.

While the effects of reducing current consumption in the standby “intermittent VREF” mode are the same as those shown in FIG. 2, the effects of reducing current consumption in the standby “intermittent VBGR” mode are provided as shown in FIG. 20.

In the standby “intermittent VBGR” mode wherein the reference voltage forming circuit 4 is kept ON at all times, the degree of effective reduction in current consumption is smaller than that in the standby “VREF” mode. Transitions involving the normal operation mode, standby “intermittent VREF” mode, standby “intermittent VBGR” mode, and overlap state are made as shown in FIG. 21.

### Preferred Embodiment 3

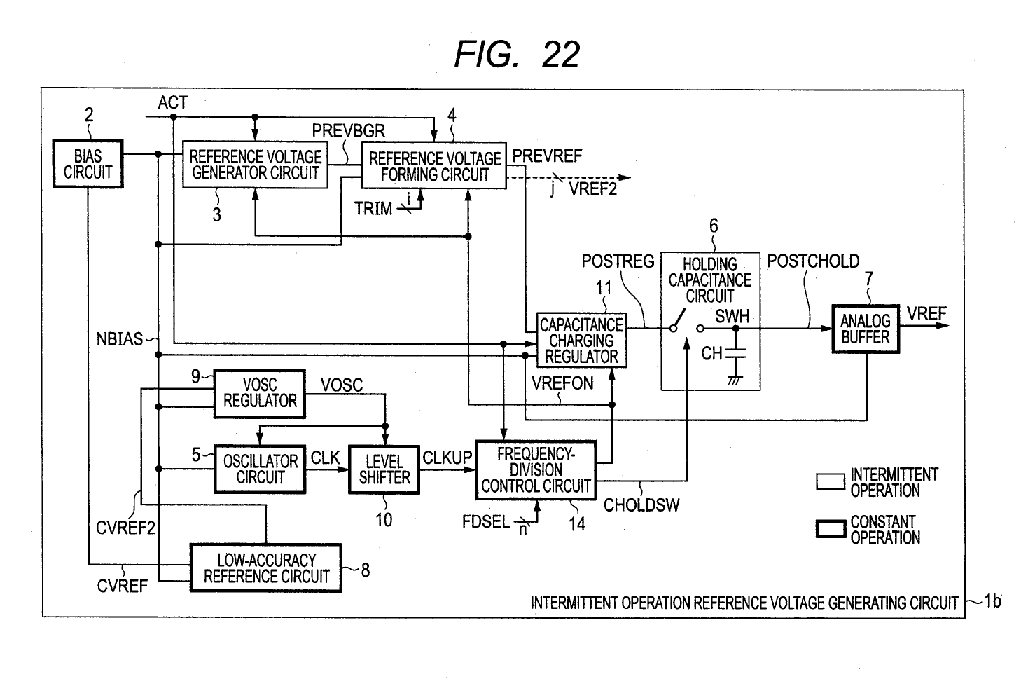

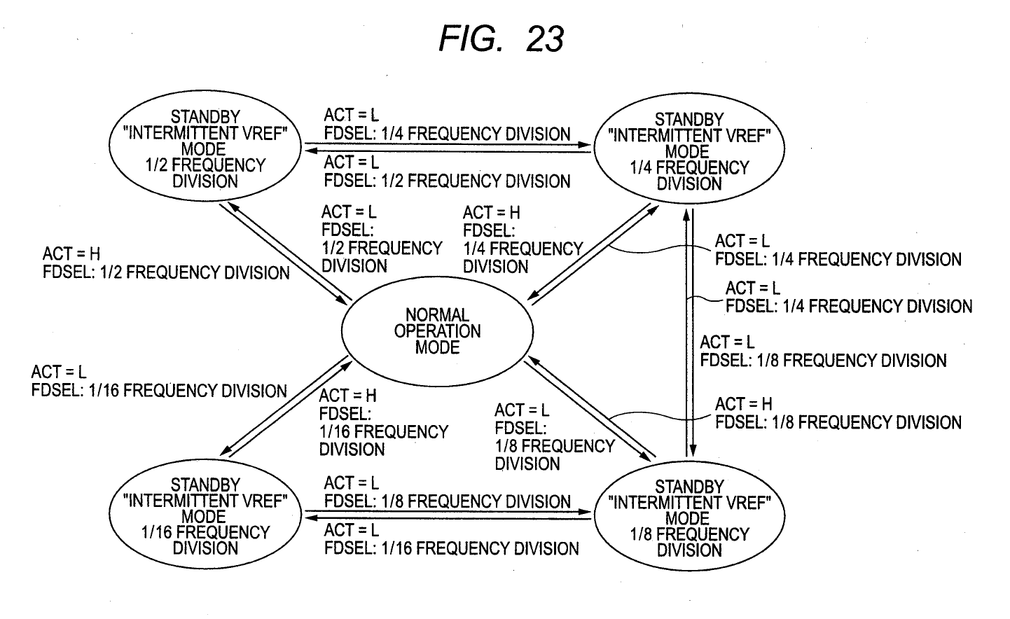

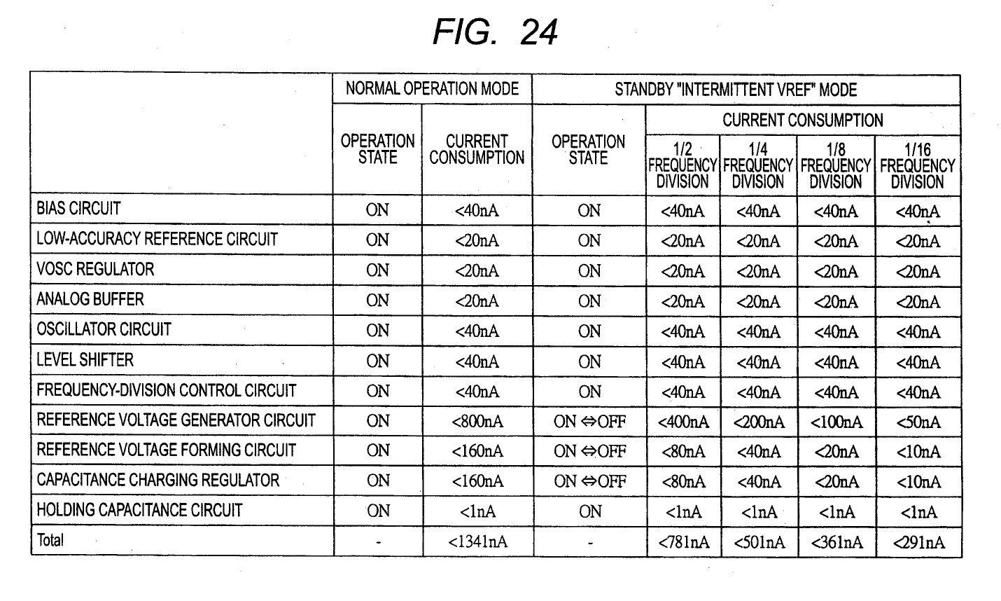

FIG. 22 shows a block diagram of an exemplary intermittent operation reference voltage generating circuit according to a preferred embodiment 3 of the present invention; FIG. 23 shows a state transition diagram of the intermittent operation reference voltage generating circuit in FIG. 22; and FIG. 24 shows an explanatory diagram of exemplary effects of reducing power consumption by using the intermittent operation reference voltage generating circuit in FIG. 22.

According to the preferred embodiment 3 of the present invention, an intermittent operation reference voltage generating circuit 1b shown in FIG. 22 is configured to have an arrangement wherein, with the elimination of the reference changeover switches SW1 and SW2, the coupling judgment comparator 12, and the coupling delay circuit 13 from the configuration of the foregoing preferred embodiment 1 of the present invention shown in FIG. 1, a transition between the normal operation mode and the standby modes is performed by using the frequency-division-ratio changeover signal FDSEL of the frequency-division control circuit 14 and the normal/standby state selection signal ACT only (FIG. 23).

In the circuit arrangement shown in FIG. 1, at the time of transition from the standby mode to the normal operation mode, if an output of the analog buffer 7 is coupled with the reference voltage PREVREF just by changing-over of the normal/standby state selection signal ACT, an output voltage drop occurs due to a difference in impedance. The coupling judgment comparator 12 and the coupling delay circuit 13 are used to prevent the occurrence of this output voltage drop. Contrastingly, in the circuit arrangement shown in FIG. 22, since the output of the analog buffer 7 is always used as the reference voltage VREF output, the coupling judgment comparator 12 and the coupling delay circuit 13 can be excluded therefrom.

Thus, the amount of current consumption can be reduced as shown in FIG. 24 while circumventing the occurrence of a voltage drop at the time of changeover between the reference voltage PREVREF and the output of the analog buffer 7. Hence, there is no need to provide an overlap period.

### Preferred Embodiment 4

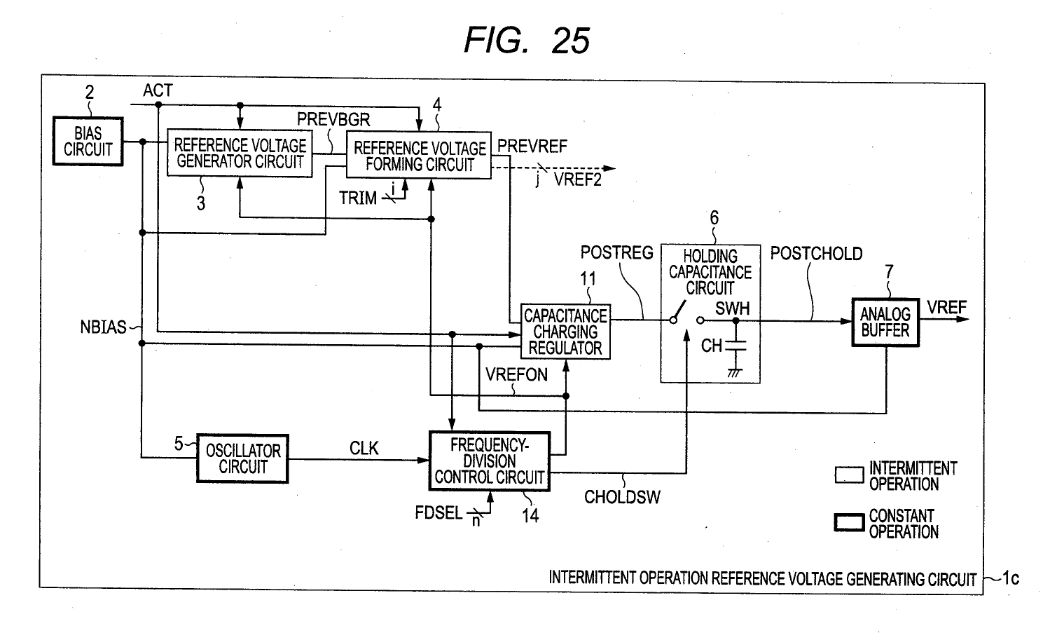

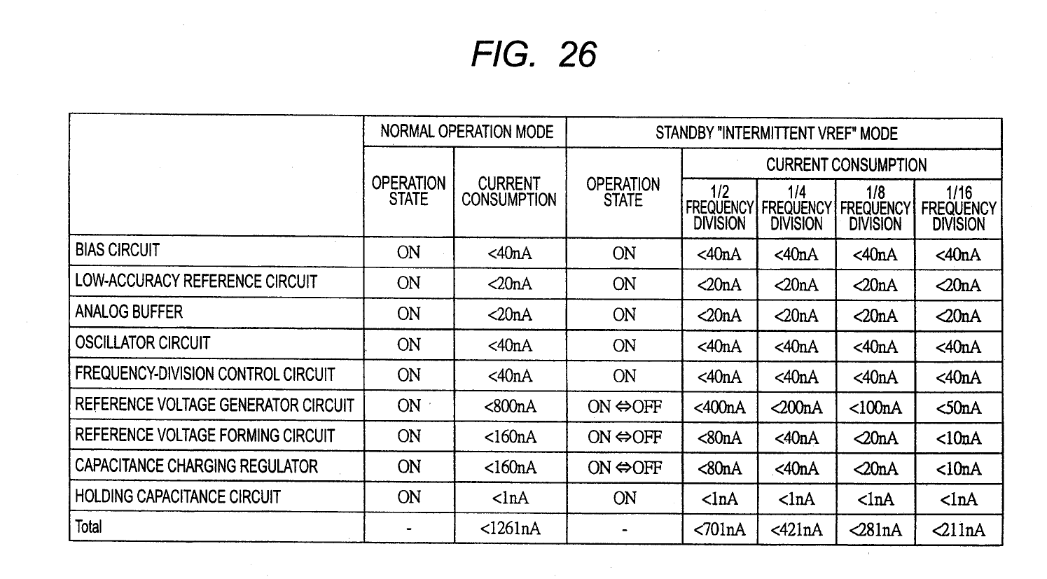

FIG. 25 shows a block diagram of an exemplary intermittent operation reference voltage generating circuit according to a preferred embodiment 4 of the present invention; and FIG. 26 shows an explanatory diagram of exemplary effects of reducing power consumption by using the intermittent operation reference voltage generating circuit in FIG. 25.

According to the preferred embodiment 4 of the present invention, an intermittent operation reference voltage generating circuit 1c shown in FIG. 25 is configured to have an arrangement wherein, with the elimination of the VOSC regulator 9 for generating the operating voltage VOSC of the oscillator circuit 5 and the level shifter 10 from the configuration of the foregoing preferred embodiment 3 of the present invention shown in FIG. 22, the oscillator circuit 5 is operated by using the external power supply voltage Vext.

The intermittent operation reference voltage generating circuit 1c has a minimum circuit configuration required for performing system power supply operation. Thus, where the coupling judgment comparator 12, the coupling delay circuit 13, the VOSC regulator 9, and the level shifter 10 are eliminated, there are no self-consumed currents that would otherwise be incurred therein, contributing to further reduction in current consumption in the standby mode as shown in FIG. 26.

### Preferred Embodiment 5

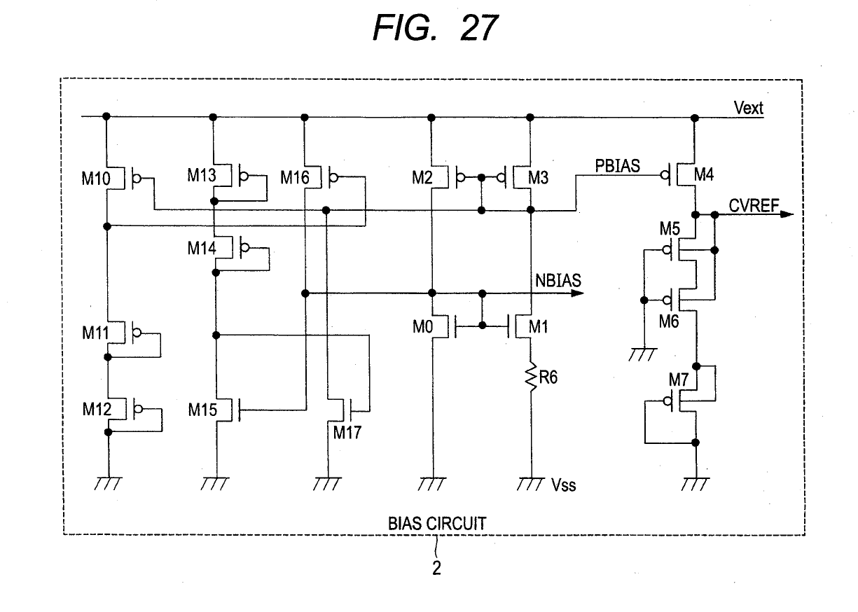

FIG. 27 shows a circuit diagram of an exemplary bias circuit provided in the intermittent operation reference voltage generating circuit according to a preferred embodiment 5 of the present invention.

In the preferred embodiment 5 of the present invention, an exemplary bias circuit 2 shown in FIG. 27 is provided for use in the intermittent operation reference voltage generating circuit 1 (1a, 1b, 1c).

As shown in FIG. 27, the bias circuit 2 comprises a Widlar current source circuit wherein a constant current is produced through use of a combination of a resistor R6 and a current mirror circuit including CMOS transistors M0 to M3.

The constant current produced is supplied to other circuits in the intermittent operation reference voltage generating circuit 1 (1a, 1b, 1c) through an NBIAS line. For a low-accuracy analog reference voltage signal CVREF output from a circuit comprising PMOS transistors M4 to M7, a negative temperature dependency characteristic of a gate-source voltage Vgs of the PMOS transistor M7 that performs saturation mode operation with diode-coupling is added to a positive temperature dependency characteristic of a drain-source voltage Vds of the PMOS transistors M5 and M6 that perform linear operation with the gate thereof fixed at the reference potential Vss. Thus, the degree of dependency on temperature is reduced substantially.

As compared with resistors and parasitic elements, the PMOS transistors M5 to M7 are susceptible to process variations. It is therefore not expectable to provide a level of trimming voltage accuracy as high as that in the case where the reference voltage generator circuit 3 is used.

Transistors M10 and M17 are arranged to form a startup circuit for the Widlar current source circuit. Since the Widlar current source circuit is configured in a self-bias circuit structure, there are provided a stable state in which no current other than a leak current is allowed to flow, i.e., no circuit operation is performed, and a normal operation state in which a constant current is supplied. The startup circuit comprising the transistors M10 to M17 is intended to prevent the bias circuit 2 from being put in the stable state (no-circuit-operation state) after turn-on of the external power supply voltage Vext.

### Preferred Embodiment 6

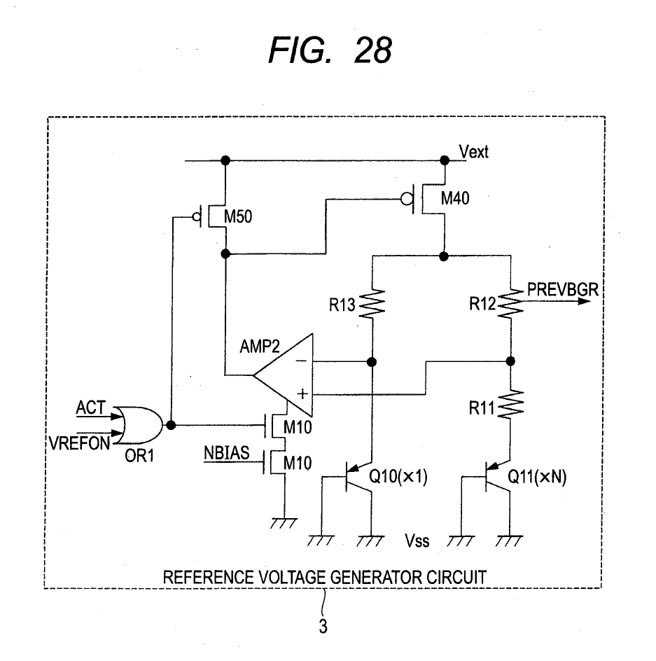

FIG. 28 shows a circuit diagram of an exemplary reference voltage generator circuit provided in the intermittent operation reference voltage generating circuit according to a preferred embodiment 6 of the present invention.

In the preferred embodiment 6 of the present invention, an exemplary reference voltage generator 3 shown in FIG. 28 is provided for use in the intermittent operation reference voltage generating circuit 1 (1a, 1b, 1c).

In the reference voltage generator circuit 3 shown in FIG. 28, an operational amplifier AMP2 thereof is arranged to operate so that a base-emitter voltage Vbe 10 of a PNP parasitic bipolar transistor Q10 becomes equal to an intermediate potential of resistors R11 and R12.

Due to current density difference in the PNP parasitic bipolar transistors Q10 and Q11, there occurs a potential difference ΔVbe with respect to a base-emitter voltage Vbe 10 of the transistor Q10 and a base-emitter voltage Vbe 11 of the transistor Q11. Since the potential difference ΔVbe has a positive temperature dependency characteristic, the potential difference ΔVbe is multiplied by a resistance ratio of R13/R11, and the resultant voltage obtained in the multiplication is added to the base-emitter voltage Vbe 10 having a negative temperature dependency characteristic. Thus, a reference voltage PREVBGR having less dependency on temperature is produced as indicated by the expression of [PREVBGR=Vbe 10+(R13/R11)×ΔVbe].

It is to be noted that the PNP parasitic bipolar transistors Q10 and Q11 are semiconductor elements that can be formed by standard CMOS process, i.e., no substantial increase in production process cost is required additionally for forming the PNP parasitic bipolar transistors Q10 and Q11.

### Preferred Embodiment 7

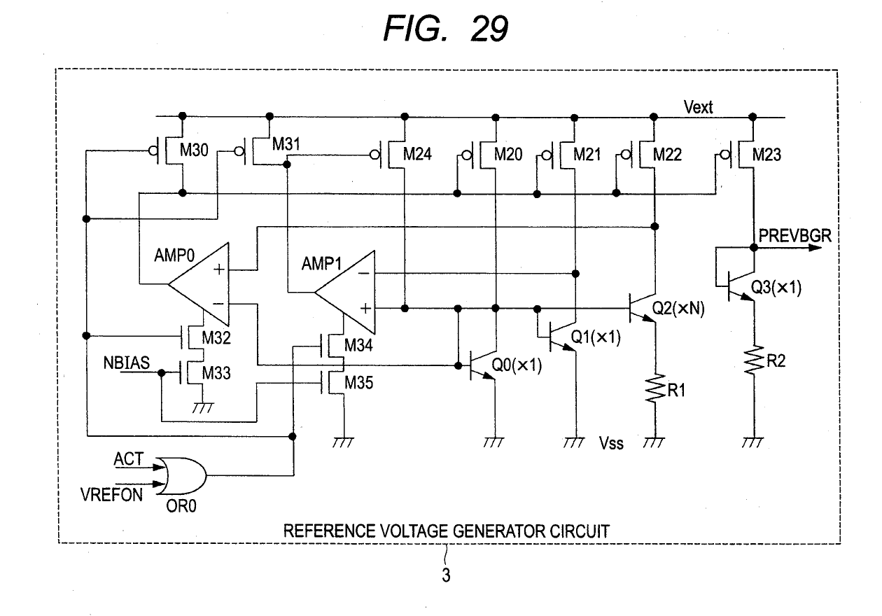

FIG. 29 shows a circuit diagram of an exemplary reference voltage generator circuit in the intermittent operation reference voltage generating circuit according to a preferred embodiment 7 of the present invention.

In the preferred embodiment 7 of the present invention, there is provided another exemplary configuration of the reference voltage generator circuit 3 set forth in the above description of the preferred embodiment 6 of the present invention.

As shown in FIG. 29, the reference voltage generator circuit 3 in the preferred embodiment 7 of the present invention uses NPN transistors Q1 to Q3 that are parasitic bipolar transistors. By utilizing the parasitic NPN transistors Q1 and Q2 as three-terminal elements, the degree of offset in input voltage to each of operational amplifiers AMP0 and AMP1 is reduced to enhance pre-trimming voltage accuracy of the reference voltage PREVBGR.

Similarly to the circuit arrangement of the reference voltage generator circuit 3 shown in FIG. 28, a base-emitter voltage ΔVbe of the NPN transistor Q1/Q2 is extracted through the operational amplifier AMP0/AMP1 with a resistor R1. Since a voltage comparison is performed on the collector side of the transistor Q1/Q2, the degree of input voltage offset can be reduced consequently at a ratio of collector current Ic to base current 1b, as expressed by [hfe=Ic/Ib].

To provide parasitic NPN bipolar transistors having a relatively large ratio value of “hfe”, collectors thereof are formed in DEEP-NWELL regions in common practice. It is therefore required to carry out triple-well-structure CMOS process which is a combination of standard CMOS process and DEEP-NWELL region formation.

Although additional process steps required for DEEP-NWELL region formation will result in an increase in production process cost, DEEP-NWELL regions may be used to provide a part of an ESD (electrostatic discharge) protecting element for transistors disposed in an I/O region. In common applications, DEEP-NWELL regions are often used for internal-chip modules such as ADC (analog/digital converter) circuits for substrate noise isolation, and by using DEEP-NWELL regions, parasitic NPN transistors may be provided for enhancement in voltage accuracy of the reference voltage generator circuit 3.

### Preferred Embodiment 8

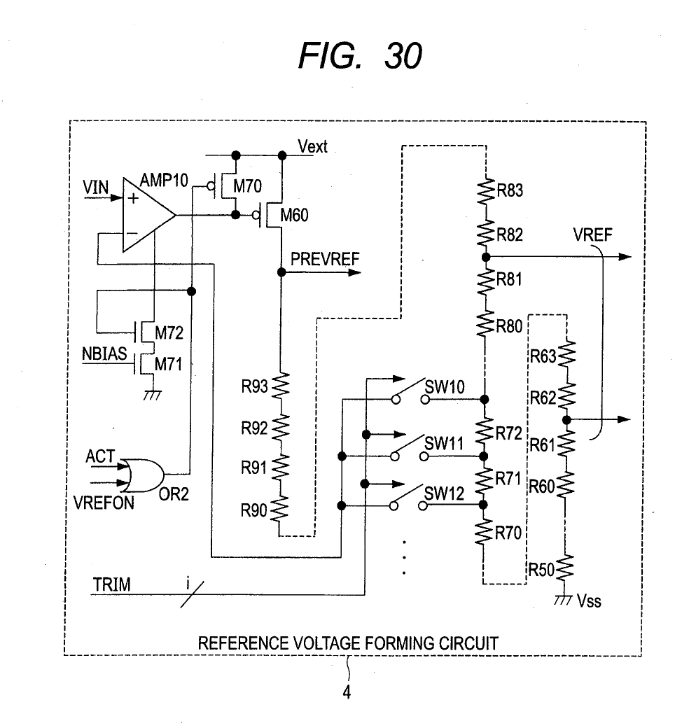

FIG. 30 shows a circuit diagram of an exemplary reference voltage forming circuit provided in the intermittent operation reference voltage generating circuit according a preferred embodiment 8 of the present invention.

In the preferred embodiment 8 of the present invention, an exemplary reference voltage forming circuit 4 shown in FIG. 30 is provided for use in the intermittent operation reference voltage generating circuit 1 (1a, 1b, 1c).

As shown in FIG. 30, the reference voltage forming circuit 4 comprises an operational amplifier AMP10, transistors M60 and M70 to M72, a logical OR circuit OR2, switches SW10 to SW12, and resistors R50 to R63, R70 to R72, R80 to R83 and R90 to R93.

Receiving a voltage fed from the reference voltage generator circuit 3 or the like as an input voltage VIN, the reference voltage forming circuit 4 performs voltage conversion according to the resistance ratio concerned to produce the reference voltages PREVREF and VREF2 required for operations of the intermittent operation reference voltage generating circuit.

It is to be noted that the reference voltages PREVREF and VREF2 can be adjusted by using the trimming signal TRIM having “i” bits.

### Preferred Embodiment 9

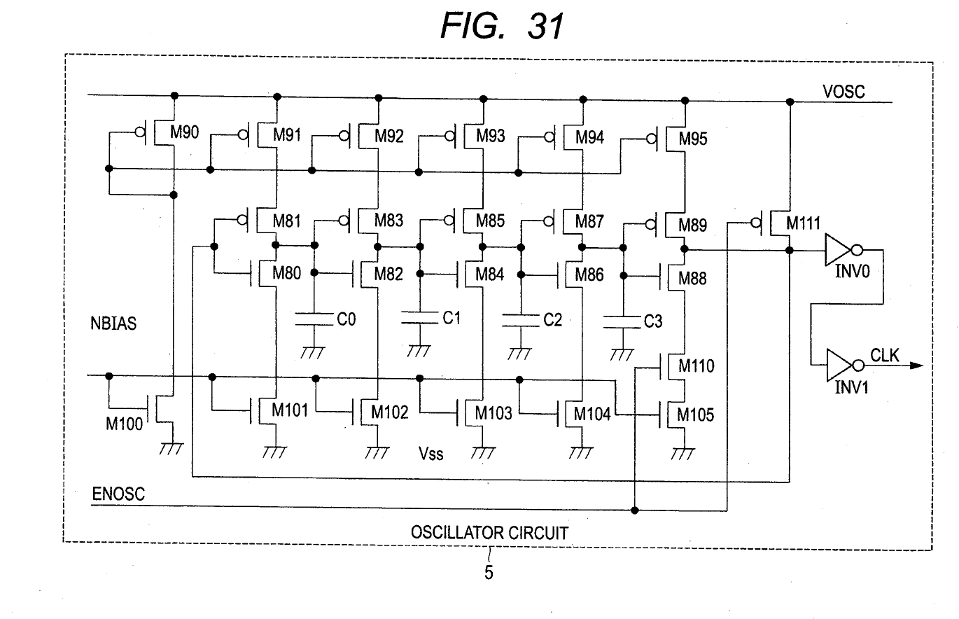

FIG. 31 shows a circuit diagram of an exemplary oscillator circuit provided in the intermittent operation reference voltage generating circuit according to a preferred embodiment 9 of the present invention.

In the preferred embodiment 9 of the present invention, an exemplary oscillator circuit 5 having the configuration shown in FIG. 31 is provided for use in the intermittent operation reference voltage generating circuit 1 (1a, 1b, 1c).

As shown in FIG. 31, the oscillator circuit 5 comprises transistors M80 to M89, M90 to M95, M100 to M105, M110 and M111, capacitors C0 to C3, and inverters INV0 and INV1. There is provided a ring oscillator structure comprising an odd number of inverter circuit stages (five sages in FIG. 31) for determining oscillation frequencies of the constant current fed from the bias circuit 2, the operating voltage VOSC produced by the VOSC regulator 9 for the oscillator circuit 5, and the reference clock signal CLK produced according to values of the capacitor C0 to C3.

### Preferred Embodiment 10

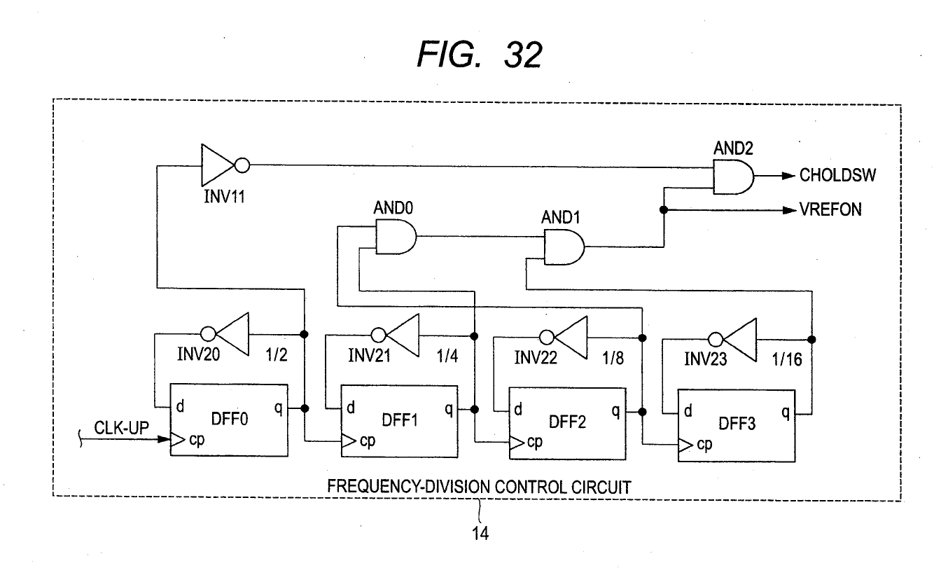

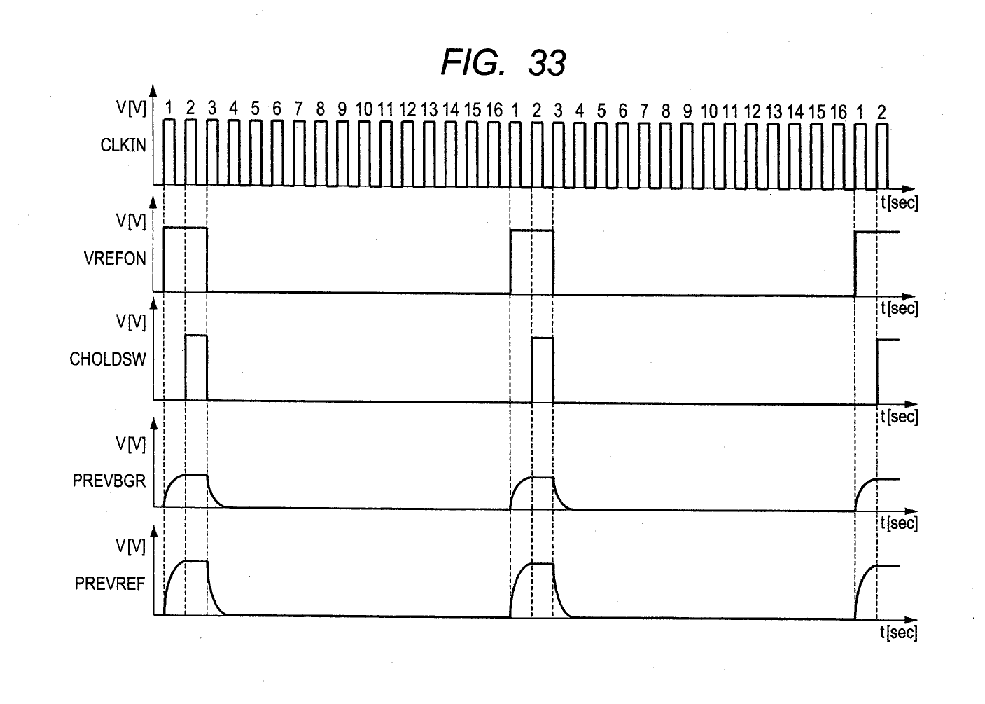

FIG. 32 shows a circuit diagram of an exemplary frequency-division control circuit provided in the intermittent operation reference voltage generating circuit according to a preferred embodiment 10 of the present invention; and FIG. 33 shows a timing chart of exemplary operating waveforms in the frequency-division control circuit in FIG. 32.

In the preferred embodiment 10 of the present invention, an exemplary frequency-division control circuit 14 having the configuration shown in FIG. 32 is provided for use in the intermittent operation reference voltage generating circuit 1 (1a, 1b, 1c).

As shown in FIG. 32, the frequency-division control circuit 14 receives the reference clock signal CLK produced by the oscillator circuit 5 or the clock signal CLKUP obtained from the reference clock signal CLK through voltage amplitude conversion by the level shifter 10. The frequency of the reference clock signal CLK or the clock signal CLKUP is divided by a frequency-division circuit comprising edge-trigger D-type flip-flop circuits DFF0 to DFF3 and inverters INV20 to INV23. Then, the enable signal VREFON and the sampling/holding signal CHOLDSW are produced by logic circuits (inverter INV11, and logical AND circuits ANDO to AND2).

Referring to FIG. 33, there are shown exemplary operating waveforms in the frequency-division control circuit 14. In the timing sequence exemplified in FIG. 33, a clock signal CLKIN is subjected to 1/16 frequency division to provide a two-clock-cycle interval in which the enable signal VREFON becomes high and a one-clock-cycle interval in which the sampling/holding signal CHOLDSW becomes high for applying a charging voltage to the holding capacitor CH. For an interval of 14 clock cycles, such signals as the enable signal VREFON are turned OFF. Thus, in the reference voltage generator circuit 3 and the reference voltage forming circuit 4, an ON/OFF period thereof is provided on the basis of ⅛ frequency division.

### Preferred Embodiment 11

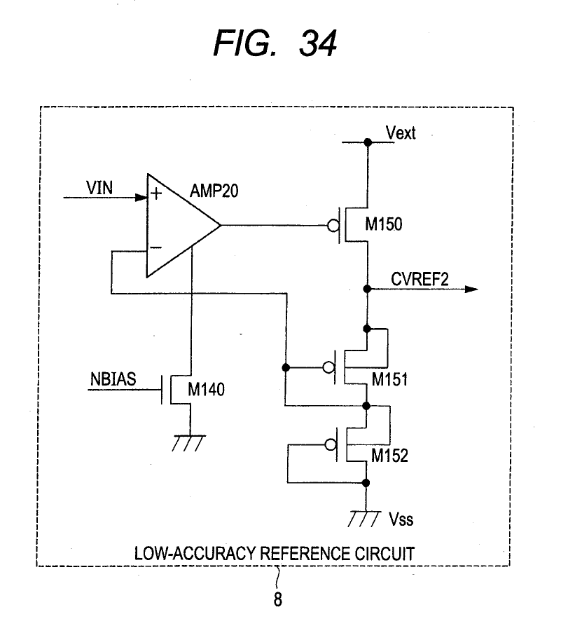

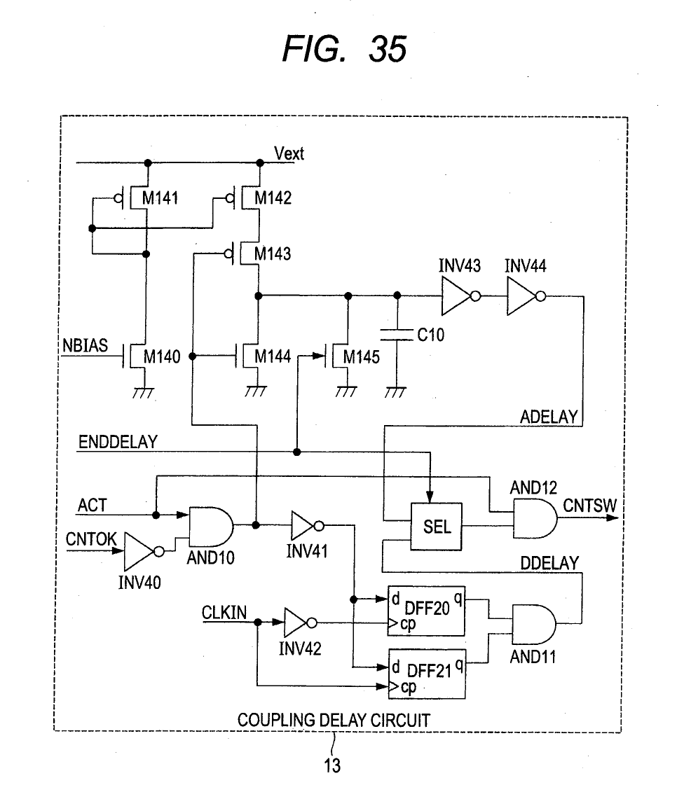

FIG. 34 shows a circuit diagram of an exemplary low-accuracy reference circuit provided in the intermittent operation reference voltage generating circuit according to a preferred embodiment 11 of the present invention; and FIG. 35 shows a circuit diagram of an exemplary coupling delay circuit provided in the intermittent operation reference voltage generating circuit according to the preferred embodiment 11 of the present invention.

In the preferred embodiment 11 of the present invention, an exemplary low-accuracy reference circuit 8 shown in FIG. 34 is provided for use in the intermittent operation reference voltage generating circuit 1 (1a, 1b, 1c).

As shown in FIG. 34, the low-accuracy reference circuit 8 comprises an operational amplifier AMP20, and transistors M140 and M150 to M152.

Although the low-accuracy reference circuit 8 is similar to the reference voltage forming circuit 4, it is not required for the low-accuracy reference circuit 8 to provide a degree of voltage accuracy as high as that of the reference voltage forming circuit 4. The low-accuracy reference circuit 8 is just required to produce the reference voltage CVREF2 that is approximately two times the voltage of the low-accuracy analog reference voltage signal CVREF supplied as an input voltage VIN. Hence, the diode-coupled MOS transistors M151 and M152 are used in lieu of resistors, thereby realizing a small-in-area circuit configuration featuring low current consumption.

Referring to FIG. 35, there is shown an exemplary circuit configuration of a coupling delay circuit 13 provided for use in the intermittent operation reference voltage generating circuit 1 (1a, 1b, 1c).

In practical applications, the coupling delay circuit 13 includes an analog or digital delay circuit, or a combination of analog and digital delay circuits. In the circuit configuration exemplified in FIG. 35, the coupling delay circuit 13 includes a combination of analog and digital delay circuits.

As shown in FIG. 35, the analog delay circuit included in the coupling delay circuit 13 comprises CMOS transistors M140 to M145, inverters INV43 and INV44, and a capacitor C10. Using a constant current of the analog reference signal NBIAS, the capacitor C10 is charged to provide a delay time to be taken until the logic threshold of the inverter INV43 is exceeded.

On the other hand, the digital delay circuit included in the coupling delay circuit 13 comprises edge-trigger D-type flip-flop circuits DFF20 and DFF21 (inverters INV41 and INV42, and a logical AND circuit AND11). Using the input clock signal CLKIN, a delay time is provided by the digital delay circuit.

Through use of the delay time mentioned above, the degree of voltage drop at the time of transition from the standby mode to the normal operation mode is reduced. A changeover between the analog delay circuit and the digital delay circuit is performed according to whether the oscillator circuit 5 is active in the normal operation mode.

While the present invention has been described in detail with respect to specific embodiments thereof, it is to be understood that the present invention is not limited by any of the details of description and that various changes and modifications may be made in the present invention without departing from the spirit and scope thereof.

As can be understood from the foregoing description, the present invention has significant industrial applicability to semiconductor integrated circuit devices including a reference voltage forming circuit for forming a reference voltage.

1. A semiconductor integrated circuit device comprising reference voltage forming means for forming a reference voltage, the reference voltage forming means comprising:
a reference voltage forming section for forming the reference voltage; and
an intermittent operation control section for intermittently activating the reference voltage forming section to form the reference voltage in a standby mode for reduction in power consumption.

2. The semiconductor integrated circuit device according to claim 1,
wherein the intermittent operation control section comprises:
a control signal forming section for converting a reference clock signal to a predetermined frequency-divided clock signal to form a first control signal an a second control signal;
a charging regulator operative in accordance with the first control signal in the standby mode for stabilizing the reference voltage formed by the reference voltage forming section;
a sample-and-hold circuit operative in accordance with the second control signal for sampling/holding a power supply voltage corresponding to the reference voltage stabilized by the charging regulator;
a buffer section for buffering a power supply voltage fed from the sample-and-hold circuit so as to output the buffered power supply voltage as the reference voltage; and
a switch section for, in the standby mode, switching the reference voltage forming section and an output part of the reference voltage forming means into non-conduction, and switching the buffer section and the output part into conduction so as to output the power supply voltage fed from the buffer section as the reference voltage, and
wherein the reference voltage forming section performs intermittent operation in accordance with the first control signal formed by the control signal forming section.

3. The semiconductor integrated circuit device according to claim 2,
wherein the intermittent operation control section further comprises an oscillator circuit for producing a reference clock signal to be fed to the control signal forming section.

4. The semiconductor integrated circuit device according to claim 3,
wherein the intermittent operation control section further comprises a regulator for the oscillator circuit, the regulator being arranged to produce a stepped-down oscillation power supply voltage from an external power supply voltage received from an external circuit and to feed the stepped-down oscillation power supply voltage thus produced to the oscillator circuit.

5. The semiconductor integrated circuit device according to claim 2,
wherein the intermittent operation control section further comprises a coupling changeover control section for performing a changeover of the switch section in such a fashion that, in transition from the standby mode to a normal operation mode, after the lapse of a predetermined delay time from when an increase in the reference voltage output from the reference voltage forming section is detected, a switch control signal is output so as to switch the reference voltage forming section and the output part of the reference voltage forming means into conduction, and to switch the buffer section and the output part into non-conduction.

6. The semiconductor integrated circuit device according to claim 1,
wherein the reference voltage forming section further comprises a function for adjusting the reference voltage at formation thereof by using a trimming signal, and
wherein, in the standby mode, the reference voltage forming section does not perform intermittent operation during a reset period that the reference voltage is adjusted by using the trimming signal.

7. The semiconductor integrated circuit device according to claim 1,
wherein the reference voltage forming means further comprises a guard ring surrounding the periphery of the reference voltage forming means.

8. The semiconductor integrated circuit device according to claim 1,
wherein the reference voltage forming means further comprises a mesh-like metal shield wiring pattern formed to cover the top of the reference voltage forming means.
